(19) United States
(12) Patent Application Publication
(10) Pub. No.: US 2025/0074595 A1
(43) Pub. Date: Mar. 6, 2025

(54) APPARATUS FOR VIRTUALLY DISPLAYING AN EXTERNAL VISUAL ENVIRONMENT OF AN AIRCRAFT AND A METHOD OF USE

(71) Applicant: JETZERO, INC., Long Beach, CA (US)

(72) Inventors: Kevin O'Leary, Long Beach, CA (US); Thomas O'Leary, Long Beach, CA (US)

(73) Assignee: JETZERO, INC., Long Beach, CA (US)

(21) Appl. No.: 18/242,911

(22) Filed: Sep. 6, 2023

(51) Int. Cl. B64D 11/00

(52) U.S. Cl. CPC B64D 11/0015; G06T 7/70; G06V 20/00; B64D 2011/0061; G06T 2207/30252

(57) ABSTRACT

An apparatus for virtually displaying an external visual environment of an aircraft, the apparatus comprising an input device, wherein the input device is configured to receive external aircraft data of an aircraft, at least a processor, a memory communicatively connected to the at least a processor, wherein the memory contains instructions configuring the processor to obtain the external aircraft data from the input device, determine a location of one or more passengers, generate a field of view as a function of the external aircraft data and the location of the one or more passengers and transmit the field of view to a display device.

### FIELD OF THE INVENTION

The present invention generally relates to the field of virtual display devices. In particular, the present invention is directed to a virtual display device on an aircraft.

### BACKGROUND

Cabin windows may only be placed along the walls of a fuselage of an aircraft. Passengers who do not have an aisle seat cannot utilize a window, and instead, must peer through a window from one or two seats away. In addition, cabin windows on an aircraft reduce the structural integrity of the aircraft. As a result, reinforcements must be placed in order to compensate for the structural integrity. Lastly, due to the design of tube and wing aircraft, cabin windows may be placed along walls of the fuselage wherein many passengers can enjoy the windows. In contrast, aircraft such as a blended wing body aircraft may not be able to place windows along a passenger cabin within the fuselage.

### SUMMARY OF THE DISCLOSURE

In an aspect an apparatus for displaying an external visual environment of an aircraft is disclosed. The apparatus includes an input device, wherein the input device is configured to receive external aircraft data of an aircraft. The apparatus further includes at least a processor, and a memory communicatively connected to the at least a processor, wherein the memory contains instructions configuring the processor to obtain the external aircraft data from the input device, determine a location of one or more passengers, generate a field of view as a function of the external aircraft data and the location of the one or more passengers and transmit the field of view to a display device.

In another aspect a method for virtually displaying an external visual environment of an aircraft is disclosed. The method includes receiving, by at least a processor, external aircraft data from an input device, determining, by the at least a processor, a location of one or more passenger, generating, by the at least a processor, at least a field of view as a function of the external aircraft data and the location of the one or more passengers and, transmitting, by the at least a processor, the field of view to a display device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of an apparatus for virtually displaying an external visual environment of an aircraft;

FIG. 2 is an exemplary embodiment of a display device located on an aircraft;

FIG. 3 is a schematic of an exemplary blended wing aircraft;

FIG. 4 is a flow diagram illustrating an exemplary method for virtually displaying an external visual environment of an aircraft; and

FIG. 5 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for an apparatus for virtually displaying an external visual environment of an aircraft. In an embodiment, apparatus may include a computing device, an input device and a display device. Using input device and computing device apparatus may be configured to display an external visual environment on display device. External visual environment may simulate an outside environment of an aircraft, wherein a passenger may use a device display in lieu of a passenger or cabin window.

Aspects of the present disclosure can be used to provide synthetic windows or skylights within an aircraft. Aspects of the present disclosure may further allow users to view surrounding areas of an aircraft in better details. Aspects of the present disclosure may further allow users to control or later their views of the surrounding areas of the aircraft. Aspects of this disclosure may further provide for synthetic windows in areas of an aircraft where windows cannot be efficiently placed. Exemplary embodiments illustrating aspects of the present disclosure are described below in the context of several specific examples.

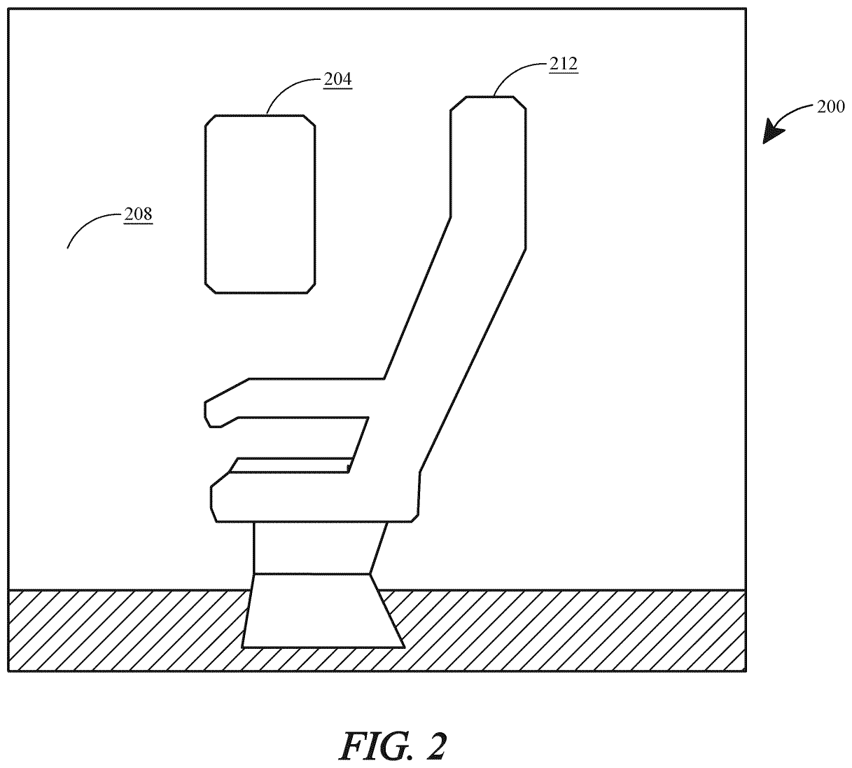

In the following description, for the purposes of explanation, numerous specific details are set forth in order to provide a thorough understanding of the present invention. For purposes of description herein, relating terms, including “upper”, “lower”, “left”, “rear”, “right”, “front”, “vertical”, “horizontal”, and derivatives thereof relate to embodiments oriented as shown for exemplary purposes in FIG. 2. Furthermore, there is no intention to be bound by any expressed or implied theory presented in this disclosure.

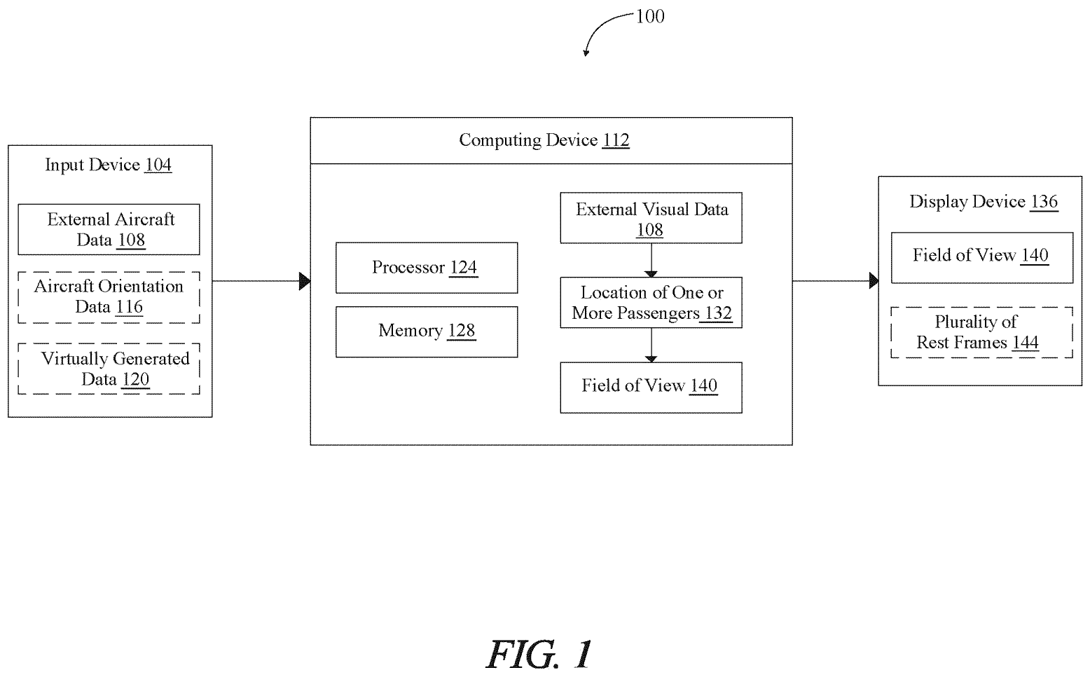

Referring now to FIG. 1, an exemplary embodiment of an apparatus 100 for virtually displaying an external visual environment of an aircraft is illustrated. “External visual environment” as described herein refers to the surrounding area of an aircraft. External visual environment may include a side view of the aircraft, a top view, a front view, a bottom view, a back view and the like. External visual environment may further include the surrounding environment of the aircraft. This may include but is not limited to any surrounding views that may be seen from an aircraft. This may include clouds, mountains, cities, buildings, the ocean, land, birds, and the like. Aircraft, as described herein may refer to any flying vehicle. This may include a tube and wing body aircraft, a blended wing body aircraft, a helicopter, a blimp, a glider plane, a cargo aircraft, a freighter aircraft, an amphibious aircraft, a rotorcraft, a tiltrotor aircraft and the like.

With continued reference to FIG. 1, apparatus 100 includes an input device 104, wherein input device 104 is configured to receive external aircraft data 108 of an aircraft. “Input device” as described herein is any component that is capable of receiving, detecting, or measuring data that may be used for data manipulation. Input device may include a computing device, a sensor, a plurality of sensors, a keyboard and the like. Input device 104 may refer to any input device 104 as described in this disclosure. Examples of an input device 104 include, but are not limited to an audio input device (e.g., a microphone, a voice response system, etc.), a video capture device (e.g., a still camera, a video camera), and any combinations thereof. Input device may further comprise sensors, wherein the sensors are configured to receive external aircraft data 108. Input device may include inertial sensors such as an accelerometer (e.g. measure speed of aircraft), a gyroscope (e.g. measuring orientation or angular velocity of the aircraft), inertial measurement units (IMUs) and the like. Input device 104 may further include sensors such as, optical sensors, photonic sensors, gyroscopic sensors, proximity sensors, accelerometers, humidity sensors, temperature sensors, magnetometers and the like. Input device may further contain any sensor or component capable of receiving, detecting, or measuring data relating to the orientation, speed, altitude of an aircraft. In some embodiments input device may include a sensor configured to track or detect pilot controls. “Pilot controls” as described herein are aircraft components that allow a pilot to fly or maneuver an aircraft. Pilot controls may include a yoke, a level, switches, knob, flight controls, avionics and the like. Input device 104 may be used to detect pilot controls wherein input device may receive pilot data. Pilot data may be used by a computing device as described in this disclosure to make determinations. In some embodiments, input device 104 may include a video capture device. A “video capture device” as described herein is a device capable of recording audio, video, or both. Input device 104 may include any video capture device capable of recording audio-visual data. In some embodiments, input device 104 may include a camera. Input device 104 may be configured to transmit data to a computing device 112. Input device 104 may be interfaced to bus via any of a variety of interfaces (not shown) including, but not limited to, a serial interface, a parallel interface, a game port, a USB interface, a FIREWIRE interface, a direct interface to bus, and any combinations thereof. In some embodiments input device 104 may be configured to receive data. Input device 104 may receive image data wherein image data is data produced by scanning a surface or area with an optical or electronic device. Input device 104 may further contain video data wherein video data is any recordable form of audio-visual information. Input device 104 may further contain sensor data correlating to any sensor that may be utilized with input device 104. In some embodiments, input device 104 may include user-generated inputs. Additionally, or alternatively, input device 104 may include computer generated inputs. In some cases, apparatus 100 may include a plurality of input devices 104.

Still referring to FIG. 1, in some embodiments, input device 104 may additionally include at least a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively where “image” is used as a verb, in this disclosure, it refers to generation and/or formation of an image.

Still referring to FIG. 1, in some embodiments, input device 104 may include a machine vision system that includes at least a camera. A machine vision system may use images from at least a camera, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ϕ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure.

With continued reference to FIG. 1, input device 104 is configured to receive external aircraft data 108 of an aircraft. External aircraft data 108 is any data relating to the surrounding environment of an aircraft. External aircraft data 108 may include, but is not limited to, video data, image data, temperature data, humidity data, elevation data (referring to the elevation of the aircraft), speed data (referring to the speed of the aircraft), incline data (referring to the incline orientation of the aircraft), aircraft orientation data 116 (referring to the orientation of the aircraft, e.g., pith, roll, yaw, attitude, angle), Inertial data, pilot control data as described above and the like. External aircraft data 108 may further include video data of the aircraft. This may include a side view of the aircraft, a top view, back view front view, bottom view and the like. External aircraft data 108 may further include data of surrounding environments. This may include, but is not limited to, video data and/or image data of surrounding clouds, mountains, oceans, lakes, land, cities and the like. External aircraft data 108 may further include a plurality of data captured from differing perspectives. For example, external aircraft data 108 may include a plurality of video data wherein the plurality of video data includes similar data captured from different views. This may include an upper view, a lower view, a side view, or any other oriented view. In some embodiments, external aircraft data 108 may be representative of an outer environment of the aircraft. In some embodiments, external aircraft data 108 may represent real-time data wherein data is acquired in real-time from a surrounding environment of the aircraft. In some embodiments, external aircraft data 108 may include virtually generated data 120 of an outside of an aircraft wherein external aircraft data 108 is a computer-generated environment. “Virtually generated data” as described herein is data created through a computer simulation as opposed to real data captured from, for example, a video input device. In some cases, input device 104 may generate a virtually generated environment or receive a virtually generated environment from a computing device 112. Additionally, or alternatively, the virtually generated environment may be representative of a surrounding environment of an aircraft. In some embodiments, external aircraft data 108 may include previously recorded data such as video data recorded on a previous occasion. In some embodiment, aircraft data may include a combination of aircraft orientation data, inertial data and/or pilot control data combined with virtually generated data 120. In this embodiment, a virtually generated environment may be created by computing device wherein computing device may generate a virtual environment based on the real data collected above. In some embodiments, external aircraft data 108 may include a combination or real-time data and previously recorded data. For example, external aircraft data 108 may include a combination of previously recorded video data and real-time altitude or humidity data of an aircraft. In some cases, virtually generated data 120 may include a combination of real data and virtual data. for example, virtually generated data 120 may include real video data of an outside of aircraft, wherein the real video data further contains virtually generated data 120. In some cases, External aircraft data 108 may further include modified data, wherein real data is modified to serve a specific purpose. For example, external aircraft data 108 may include real video data of a surrounding environment, wherein the real video data is modified to change the time of day represented within video data. Using a computing device 112, the combination or real-time and previously recorded data may be used to mimic a surrounding environment of the aircraft without the need constantly record. This may be beneficial in situations where an aircraft is traversing a previously taken route. This may further be beneficial in situations where data transfer rates are constrained such that video data may be difficult to efficiently transfer.

With continued reference to FIG. 1, apparatus 100 includes computing device 112. Computing device 112 may include any computing device 112 as described in this disclosure, including without limitation a microcontroller, microprocessor, digital signal processor (DSP) and/or system on a chip (SoC) as described in this disclosure. Computing device 112 may include, be included in, and/or communicate with a mobile device such as a mobile telephone or smartphone. computing device 112 may include a single computing device 112 operating independently or may include two or more computing device 112 operating in concert, in parallel, sequentially or the like; two or more computing devices may be included together in a single computing device 112 or in two or more computing devices. computing device 112 may interface or communicate with one or more additional devices as described below in further detail via a network interface device. Network interface device may be utilized for connecting computing device 112 to one or more of a variety of networks, and one or more devices. Examples of a network interface device include, but are not limited to, a network interface card (e.g., a mobile network interface card, a lAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing device 112s, and any combinations thereof. A network may employ a wired and/or a wireless mode of communication. In general, any network topology may be used. Information (e.g., data, software etc.) may be communicated to and/or from a computer and/or a computing device 112. computing device 112 may include but is not limited to, for example, a computing device 112 or cluster of computing devices in a first location and a second computing device 112 or cluster of computing devices in a second location. computing device 112 may include one or more computing device 112s dedicated to data storage, security, distribution of traffic for load balancing, and the like. computing device 112 may distribute one or more computing tasks as described below across a plurality of computing devices of computing device 112, which may operate in parallel, in series, redundantly, or in any other manner used for distribution of tasks or memory 128 between computing devices. computing device 112 may be implemented using a “shared nothing” architecture in which data is cached at the worker, in an embodiment, this may enable scalability of apparatus 100 and/or computing device 112.

With continued reference to FIG. 1, computing device 112 may be designed and/or configured to perform any method, method step, or sequence of method steps in any embodiment described in this disclosure, in any order and with any degree of repetition. For instance, computing device 112 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 112 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 and/or computing device 112 includes at least a processor 124 and memory 128 communicatively connected to the at least a processor 124. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device 112. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 128 contains instructions configuring at least a processor 124 to obtain external aircraft data 108 from input device 104. “Obtain” may include obtaining or receiving data using any wireless of wired connection as described in this disclosure. In some cases, processor 124 may be configured to obtain external aircraft data 108 from a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, memory 128 further contains instructions configuring at least a processor 124 to determine a location of one or more passengers 132. “Passengers” as described herein is any person on board an aircraft. Passengers may include ordinary commercial passengers, flight attendants, flight crew, flight personnel, pilots, military personnel, and the like. “Location” as defined herein refers to a position on an aircraft. “Locating” or “determine a location” as defined herein refers to receiving, obtaining, or generating data related to a specific location of an object. For example, locating a seat, may include generating or retrieving location data for a particular seat. Location may include location data. Location may include a specific passenger seat, for example and without limitation, an aisle seat located on a 3^{rd} row within an aircraft. Location may further include section of aircraft such as, without limitation, a back section of aircraft. Location may include location coordinates. Location coordinates may include coordinates indicating a particular position of aircraft. Location may be relative to aircraft wherein location only signifies a passenger's specific location within aircraft. Location may further include a geolocation wherein location includes a passenger's location relative to the earth. Location coordinates may further include coordinates that are local to the aircraft. This may include longitudinal and latitudinal coordinates. Processor 124 may determine location by receiving location data. Location data may include location coordinates as described above. Location data may include previously inputted data, such as for example, previously inputter data correlating a specific processor 124 to a specific passenger seat. Location may further be determined through user input, wherein a computer device may request an input from a passenger requesting the passengers location. A passenger's location may be input as a passenger seat number or a specific section of the aircraft. In some embodiments, location may be determined from a location data received by input device 104. In some embodiments, location data may be retrieved from a database.

With continued reference to FIG. 1, determining location of one or more passengers 132 may include locating a passenger seat. Locating passenger seat may include any determination of a passenger's location as described above. Locating passenger seat may include receiving predetermined data relating to a passenger seat. Locating passenger seat may include receiving a passenger seat number. In some embodiments locating passenger seat may include looking up location of one or more passengers 132 in a database. Additionally or alternatively, determining location of one or more passengers 132 may further include looking up location of one or more passengers in a lookup table. “Lookup table” as described herein is an array that holds a set of values wherein a specific key returns a specific value. As a non-limiting example, lookup table may contain input values of seat numbers or other places on aircraft and output values corresponding to coordinates of those locations. Determining location of one or more passengers 132 may further include locating a display device 136. Display device 136 will be explained in further detail below. Locating display device 136 may include any determination of a location as described in this disclosure. Locating display device 136 may include receiving location data from display device 136, wherein display device 136 may contain a location sensor. Locating display device 136 may further include retrieving predetermined data from a database. Locating display device 136 may further include receiving a user input from a passenger, wherein the passenger inputs the location of display device 136. Determining location of one or more passengers 132 may further include determining a location of one or more passengers 132 as a function of the location of the passenger seat and the location of the display device 136. In some cases, determining location of one or more passengers 132 may include determining location of one or more passengers 132 relative to display device 136. Determining a location relative to display device 136 may assist computing device 112 in generating proper data that is geared toward a specific passenger and their location relative to display device 136. This may be beneficial in situations when display device 136 display a surrounding environment of a passenger. Dependent on the passenger location relative to display device 136, display computing device 112 may generate data that compliments the passenger location.

With continued reference to FIG. 1, memory 128 further contains instructions configuring processor 124 to generate a field of view 140 as a function of the external aircraft data 108 and the location of the one or more passengers. “Field of view” as described herein refers to data relating to a surrounding view, or estimated surrounding view, of a passenger relative to their location within an aircraft. Field of view 140 may include data relating to a passenger's potential field of vision if the components of an aircraft was not obstructing the passenger's view. Additionally, or alternatively, field of view 140 may include data relating to a passenger's potential field of vision if aircraft was completely or partially transparent. For example, field of view 140 of a passenger located on a right side of the aircraft, may include a field of vision of a passenger located right side of the aircraft. In another nonlimiting example, field of view 140 of a passenger located on a right side of an aircraft may be similar to the field of vision of a passenger peering out through a window of a right side of aircraft. In another nonlimiting example, field of view 140 of a passenger located on a left side of an aircraft may be similar to the field of vision of a passenger peering out through a window in a left side of aircraft. Field of view 140 may include any surrounding environment of the aircraft. Field of view 140 may include any surrounding environment of a passenger relative to their location and/or location of display device 136. For example, when an aircraft is grounded, field of view 140 may include surrounding view of the airport or runway. Field of view 140 may include video data, location data, orientation data, passenger orientation data (data relating to how a passenger is seated and situated on aircraft), temperature data and the like as described in this disclosure. In some cases, field of view 140 may contain similar data to that of external aircraft data 108. Generating field of view 140 as a function of the external aircraft data 108 and the location of the one or more passengers may include receiving external aircraft data 108 and modifying external aircraft data 108 to suit the perspective of the passenger. For example, external aircraft data 108 may be partially rotated to match a passenger's perspective view. In another non-limiting example, external aircraft data 108 may be modified such that only those portions of external aircraft data 108 that suit a passenger's perspective view is used. Continuing the example, external aircraft data 108 may include video data capturing a 360-degree view of the aircraft, whereas field of vision data may only include a 180-degree view of aircraft relative to the passenger's location. Similarly, external aircraft data 108 may include a “zoomed out view” wherein the zoomed-out view captures a larger surface area, and field of view 140 may include a “zoomed in view” wherein the zoomed in view is a smaller area relative to a passenger's location. In some cases, field of view 140 may include an angled view of video data wherein a user might be peering into display device 136 at an angle. In another non-limiting example, external aircraft data 108 may be modified such that an altitude data within field of view 140 data correlates to the altitude of a specific passenger. Generating field of view 140 as a function of the external aircraft data 108 may include modifying field of view 140 using the location of one or more passengers 132. Generating field of view may further include using inertial data, aircraft orientation data 116 and or pilot control data to generate a virtual field of view. Virtual field of view as described herein is a computer-generated view of the surrounding area of an aircraft wherein the computer-generated view uses external aircraft data 108 to determine the correct orientation and/or perspective of the surrounding environment of an aircraft. For example, a virtual field of view may generate images or videos depicting rain on an outside of an aircraft based on humidity data collected from input device indicating that it is raining outside the aircraft. Similarly virtual field of view may generate images that are slightly angled in order to mimic the roll, pitch, or way of the aircraft. Generating field of view may further include receiving pilot input data wherein an aircraft orientation may be determined and generated in order to properly depict a realistic field of view for aircraft 132. Field of view 140 may further include previously recorded videos wherein the previously recorded videos are manipulated to depict a surrounding area of the aircraft. for example, field of view 140 may include video data of a previous morning flight, however the video data may be manipulated to make video data appear as through it is night. Additionally, or alternatively field of view 140 may include previously recorded data of a flight wherein input device may be used to determine at what point in the flight video data within field of view may be displayed. For example, aircraft orientation data indicating that a flight is taking off may be used to depict a section of the previously recorded flight when the previously recorded flight was taking off. Additionally, or alternatively previously recorded flight data may be manipulated as a function of external aircraft data wherein previously recorded flight data may be slowed down or sped up in order to match the speed of the aircraft.

With continued reference to FIG. 1, generating a field of view 140 as a function of the external aircraft data 108 and the location of the one or more passengers 132 may include receiving eye tracking data of the one or more passengers. “Eye tracking data” as described herein is data referring to the movement of a passenger's pupils or eyes. As a passenger moves, their field of vision changes. As a result, field of view 140 may change as well. Field of view 140 may be generated as a function of eye tracking data such that field of view 140 generates a field of vision relative to a passenger's field of vision. Eye tracking data may be received by an input device 104 as described in this disclosure. input device 104 may be situated relative to a passenger such that input device 104 may sense the movement of a passenger and collect eye tracking data Generating field of view 140 may further include determining a passenger perspective view of the one or more passengers as a function of the eye-tracking data and the location of the one or more passengers. “Passenger perspective view” as defined herein refers to the field of vision of the passenger. Passenger perspective view may be determined using eye tracking data and the Location of one or more passengers 132 wherein computing device 112 may generate a perspective view as a result of the combination. Generating field of view 140, may further include generating a field of view 140 as a function of external aircraft data 108 and passenger perspective view. In one or more embodiments, field of view 140 may be generated by combining views from two or more cameras with known locations in order to determine the precise location of the passenger's eyepoint in 3D coordinates. This capability may then be used, in part, to modify the presented virtual view according to the passenger's eyepoint. For example, the passenger might lean forward to see something farther aft in the view. This would have the effect of shifting the view to show something farther aft. Similarly, moving closer to the “window” display would result in a wider field of view.

With continued reference to FIG. 1, processor 124 and/or computing device 112 may generate field of view 140 by using an optical flow method. An “optical flow method” as described herein is a technique used to estimate to the motion of objects within an image. Motion of object within an image may be estimated based on the relative motion between an observer and a scene. Optical flow may be used to detect independently moving objects within a video. An optical flow method may be used to determine the relative motion between moving objects within a video. The moving objects may then be used as a basis for field of view 140 wherein processor 124 may slow down or speed up a video in order to match the speed of an aircraft to the speed of an object within the video. Optical flow may be estimated using a farneback method, a pyramidal method, a block matching method, a lucas-Kanade method and the like. Processor 124 may use an optical flow method to track the movement of objects within a real video or a computer-generated video of a surrounding environment of an aircraft and match the relative speed of the objects in the video to the speed of the aircraft. field of view 140 may be generated using optical flow method wherein the virtual field of view may mimic the outside environment.

With continued reference to FIG. 1, computing device and/or processor 112 may generate field of view by adjusting a playback rate of a previously recorded data. computing device may adjust playback rate by determining the speed of the aircraft using external aircraft data and adjusting the playback rate of the previously recorded data to match the speed of the aircraft. Similarly computing device 112 may adjust the playback rate of a virtually generated data 120 in order to match the speed of an aircraft. Additionally, or alternatively, gyroscopic data may be used by computing device to determine an orientation of the aircraft wherein computing device may orient the view of the previously recorded data and/or virtually generated data in order to match the orientation of the aircraft.

With continued reference to FIG. 1, computing device 112 may generate field of view 140 by receiving external aircraft data and creating a 3d model of a virtual environment as a function of the external aircraft data. For example, computing device 112 may use external aircraft data 108 to determine the time of day and the weather conditioning outside of aircraft wherein computing device may generate a similar environment, such aa sunny day or rain. Computing device may continuously receive aircraft orientation data in order to consistently update the 3D environment and generate a realistic representation of the outside of an aircraft. In some cases, generating field of view may include receiving data from a headset such as an augmented reality device. In some cases, the headset may include sensors wherein the sensors are configured to determine a location or orientation of a passenger, the passenger's view, head movements associated with the passenger and the like. In some cases, generating field of view may include receiving data from one or more sensors on the headset wherein field of view 140 is generated based on a user's movements. For example, and explained further below, field of view 140 may be generating based on a user's head movements wherein moving of a user's head up or down may change the field of view 140 to a view of above the aircraft or below the aircraft. In some cases computing device 112 may receive an orientation of one or more sensors on the headset and modify field of view based on the orientation. In some cases, field of view may include a 360-degree view of the surrounding aircraft wherein computing device may only select a portion of the view to be transmitted to the user's headset wherein a user's head orientation may be determinative of the selected portion to be displayed. For example, computing device 112 may display a left side of the aircraft when a user is looking to the left of their passenger seat.

With continued reference to FIG. 1, display device 136 may include one or more sensors such as for example, and without limitation, an accelerometer, a gyroscope, magnetometer, barometer, inertial measurement units (IMUs) and the like. Display device 136 may further include sensors such as, optical sensors, photonic sensors, gyroscopic sensors, proximity sensors, accelerometers, humidity sensors, temperature sensors, and the like. Display device 136 may further contain any sensor or component capable of receiving, detecting, or measuring data relating to the orientation, location and positioning of a passenger on an aircraft. In some cases, generating field of view 136 may further include receiving an orientation of the display device 136. In some cases, display device 136 may be positioned in one or more positions and one or more angles, wherein field of view 140 may be generated as a function of the location of display device 136. In some cases, the device display 136 sensors may be coupled with external aircraft data 108 to enable the passenger to change the orientation of the view by changing the device display orientation 136. In some cases, processor 108 may receive data from the one or more sensors of display device and generate a field of view 140 as a function of the one or more sensors. In some cases, a passenger may desire to position display device in various angles wherein each angle or position may represent a differing field of view. In some cases, field of view 140 may differ for every orientation of the display device. In some cases, processor 108 may receive an orientation of display device 136 and generate a field of view as a function of display device. Furthermore, the device orientation and field of view 140 as seen by the passenger may be combined to create a virtual window in the airplane so that the view of the outside fits the view of the device display 136 as seen by the passenger. In this case, the airplane system must know not only the location of the passenger's viewpoint but also the location of the device display 136, even as it is moved and reoriented. In one embodiment, the field of view 140 provided on the device display 136 may be equal to the field of view subtended by the device display as seen by the passenger. Alternatively, the airplane system or passenger may change to field of view as seen by the passenger on the device display to be wider (zoom out) or narrower (zoom in). This might be controlled by the passenger on their device via a device control input. This effect might also be achieved by the passenger moving the device display 136 closer or farther from their eyepoint. In one or more embodiments, computing device 112 may be communicatively connected to one or more digital binocular displays. “Binocular display” for the purposes of this disclosure is a display that is composed of 2 separate displays which are directed separately to the left and right eye. In one or more embodiments binocular display may provide binocular (3D) vision. In one or more embodiments, computing device 112 may use one or more sensors in order to track the eyes, head, and/or location of the passenger in order to provide a binocular display. In one or more embodiments, the sensors may include any sensors as described in this disclosure. In one or more embodiments, the sensors may include orientation sensors, wherein turning of a head of the passenger may result in a corresponding change in view. In one or more embodiments, distance from the display may be nominally constant, and as a result, there may be no need to determine a distance from the display to a passenger's eyes. In one or more embodiments, apparatus 100 may include binocular airplane cameras (sensors) pointing in all directions providing a fuse, binocular view. This may support normal or enhanced three-dimensional effect. The 3-D effect may be enhanced by selecting binocular cameras with a larger inter-pupillary distance.

With continued reference to FIG. 1, memory 128 contains instructions configuring processor 108 to transmit field of view 140 to display device 136. Examples of a display device 136 include, but are not limited to, a liquid crystal display (LCD), a cathode ray tube (CRT), a plasma display, a light emitting diode (LED) display, and any combinations thereof. Computing device 112 and/or memory 128 and processor 124 may include a video display adapter for communicating a displayable image to Display device 136. Display adapter and display device 136 may be utilized in combination with processor 124 to provide graphical representations of aspects of the present disclosure. In some cases, display device 136 may be a device that is fixed to an aircraft, such as for example, a device fixed to the back of a passenger seat, or along a wall of an aircraft. In some cases, display device 136 may further include a remote device and/or a personal remote device belonging to the passenger, such as for example, and without limitation, a smart phone, smart tablet, laptop and the like. In some cases, transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. In addition, Display device 136 may include one or more peripheral output devices including, but not limited to, an audio speaker Such peripheral output devices may be connected to a bus via a peripheral interface. Examples of a peripheral interface include, but are not limited to, a serial port, a USB connection, a FIREWIRE connection, a parallel connection, and any combinations thereof. Field of view 140 may be transmitted to display device 136 through a wired communication or through a wireless communication as described in this disclosure. Display device 136 may receive field of view 140 and display view of view to a passenger. In Some embodiments, field of view 140 may contain video data wherein display device 136 displays audio-visual data to a passenger. In some embodiments, display device 136 may display field of view 140 at a minimum of 60 frames per second. In some embodiments, display device 136 may display field of view 140 at a minimum of 24 frames per second. A higher frame rate may reduce latency with a video and provide smoother video data. Higher frame rate may decrease blur in a video and give a more realistic impression of the video being displayed. Additionally, or alternatively display device 136 may contain a 60 hertz display. In some embodiments, display device 136 may include a 144 hz display. Higher frame rate may reduce discomfort of a passenger by providing a passenger with a realistic view of the surrounding area of an aircraft. In some cases, a passenger may feel discomfort when there is a lag between a felt motion and visually perceived motion. As a result, it may be beneficial to increase frame rate to provide for a clearer and smoother display. In some embodiments, transmitting field of view 140 to display device 136 may include transmitting field of view 140 using a high-speed video cable. “High-speed video cable” as described herein in a wired connection between a computing device 112 and a display wherein the wired connection provides for quick data transfer to and from computing device 112. high speed video cables may use data encoding in order to increase a data transfer rate along the cable. High speed video cable may convert data into binary code wherein display device 136 may receive the binary code and convert it back into a displayable data. High speed video cable may include an HDMI cable. High speed video cable may further include optical fibers wherein the optical fibers may transfer a large volume of data in a short period of time. High speed video cable may further include a copper-based cable. In some embodiments, high speed video cable transmits data fast enough such that the lag between a felt motion on an aircraft may be reduced in comparison the to the perceived motion on display device 136. In one or more embodiments high speed cable may allow for a maximum time delay of 1 second, and/or alternatively a maximum of 0.1 seconds, in order to reduce motion sickness associated with delayed images being displayed on display device 136.

With continued reference to FIG. 1, device display 136 may include a wearable device such as a virtual reality headset and/or an augmented reality headset. Such a device may include orientation sensors. These may be connected to apparatus 100 so that the view from the headset corresponds to the view from an aircraft for the appropriate headset orientation. For example, turning the head (and headset) would turn the field of view 140 of the passenger. Such a headset may provide a binocular view including a stereoscopic, three-dimensional view from the aircraft sensors. Input device 104 may include sensors located in multiple positions on an aircraft so that a suitable stereo pair of sensor locations may be selected depending on the headset orientation. Multiple views within external aircraft data 108 may be combined to provide a synthetic but realistic view from a selected interpolated sensor location or from an extrapolated sensor location beyond the bounds of an physical airplane. Locations of the paired actual or synthetic viewpoints may be selected by processor 124 according to view orientation and degree of desired binocular effect judged favorable by computing device 112. Alternatively, the binocular separation of viewpoints may be selected by a passenger to obtain a desired binocular effect. A wider separation of binocular viewpoints may tend to provide an enhanced binocular effect. An enhanced effect may tend to increase the apparent separation of objects at different distances. For example, the apparent height of mountains may be increased by increasing ocular separation. This effect is the opposite of flattening. One method of enabling the display methods described above may to provide multiple aircraft sensors that cover the entire sphere around the airplane. Images (data) from these sensors may be “stitched” together to form a single, spherical image that may be viewed from the inside. A selected portion of this view may be provided to device display 136. Building on the prior discussion of multiple viewpoints, more than one spherical image can be created. Different spherical views can be paired to provide stereoscopic views. Some spherical views may be created synthetically by interpolation or extrapolation from data from aircraft sensors. These synthetic views may be from a selected or variably selected viewpoint (spherical center). In addition to providing external aircraft data by input device 104 to device display 136, additional data not received by input device 104 may be provided. For example, in nighttime flight, celestial objects may be added to the field of view 140. These objects may be retrieved from a database as described in this disclosure. These could be of very high resolution to enable zooming in to a high degree. Other data might include highlighting and identification of landmarks, rivers, mountains, cities, political borders, highways, and so on. This data may also be retrieved from a database as described in this disclosure. computing device 112 may further be configured to retrieve a location of an aircraft wherein computing device 112 may use the geographical location to determine surrounding landmarks, rivers, mountains, cities and the like. Computing device 112 may receive location from input device 104. This data may further be virtually and/or computer generated as described in this disclosure. In some cases, stereo sound may be provided by the device display 136. Stereo sound may be tailored in phase, volume and other characteristics to impart a sensation of direction, distance, and variation in speed (Doppler effect). This might be used to direct a passenger's attention in a certain direction to a possibly interesting subject. In a non-limiting example, sound may be to indicate to the passenger (or pilot) the location and distance of nearby aircraft. In some cases, a user may desire to spot an aircraft some miles away and track it as it flies past. In some cases, processor 124 may receive locations of one or more aircrafts from a database, such as a flight tracking database wherein processor 124 may receive the location of one or more aircraft. In some cases, the flight tracking database may further include the model, shape and size of the aircraft passing by. In some cases, apparatus 100 may be configured to communicate with an application program interface wherein apparatus may be configured to communicate with other computing devices to receive locations of one or more aircraft. In some cases, the computing device may be located on a passing aircraft. Types of aircraft may be indicated by their (synthetic) sound signature. In some embodiments, processor 124 may receive locations of one or more aircraft by querying a flight tracking application programming interface (API). An “API,” for the purposes of his disclosure, is a programming interface through which two or more computer programs may interact. Processor 124 may query flight tracking API with the location of the aircraft. Flight tracking API may return data concerning one or more aircraft that are near that location.

With continued reference to FIG. 1, display device 136 may include an augmented reality device. An “augmented reality” device, as used in this disclosure, is a device that permits a user to view a typical field of vision of the user and superimposes virtual images on the field of vision. Augmented reality device may include a view window, defined for the purposes of this disclosure as a portion of the augmented reality device that admits a view of field of vision; view window may include a transparent window, such as a transparent portion of goggles such as lenses or the like. Alternatively, view window may include a screen that displays field of vision to user. Augmented reality device may include a projection device, defined as a device that inserts images into field of vision by projecting the images onto the view window. Where view window is a screen, projection device may include software and/or hardware.

With continued reference to FIG. 1, augmented reality device may be implemented in any suitable way, including without limitation incorporation of or in a head mounted display, a heads-up display, a display incorporated in eyeglasses, googles, headsets, helmet display system, or the like, a display incorporated in contact lenses, an eye tap display system including without limitation a laser eye tap device, VRD, or the like. Augmented reality device may alternatively or additionally be implemented using a projector. Persons skilled in the art, upon reviewing the entirety of this disclosure, will be aware of various optical projection and/or display technologies that may be incorporated in augmented reality device consistently with this disclosure.

With continued reference to FIG. 1, view window, projection device, and/or other display devices incorporated in augmented reality device may implement a stereoscopic display. A “stereoscopic display,” as used in this disclosure, is a display that simulates a user experience of viewing a three-dimensional space and/or object, for instance by simulating and/or replicating different perspectives of a user's two eyes; this is in contrast to a two-dimensional image, in which images presented to each eye are substantially identical, such as may occur when viewing a flat screen display. Stereoscopic display may display two flat images having different perspectives, each to only one eye, which may simulate the appearance of an object or space as seen from the perspective of that eye. Alternatively or additionally, stereoscopic display may include a three-dimensional display such as a holographic display or the like. Persons skilled in the art, upon reviewing the entirety of this disclosure, will be aware of various alternative or additional types of stereoscopic display that may be employed in display device 136.

With continued reference to FIG. 1, augmented reality device may include at least a motion sensor. At least a motion sensor may include, without limitation, a microelectromechanical system (MEMS) sensor. At least a motion sensor may include, without limitation, an inertial measurement unit (IMU). At least a motion sensor may include one or more accelerometers; one or more accelerometers may include a plurality of accelerometers, such as three or more accelerometers positioned to span three dimensions of possible acceleration, so that any direction and magnitude of acceleration in three dimensions may be detected and measured in three dimensions. At least a motion sensor may include one or more gyroscopes; one or more gyroscopes may include a plurality of gyroscopes, such as three or more gyroscopes positioned to span three dimensions of possible acceleration, so that any direction and magnitude of change in angular position in three dimensions may be detected and measured in three dimensions.

With continued reference to FIG. 1, sensor may be any sensor that detects an input. Sensor may include plural sensors. Sensor may include an optical or image sensor (e.g. a camera, a CMOS detector, a CCD detector, a video camera, a photodiode, a photovoltaic cell, a photoconductive device, or the like), proximity sensor, inertial measurement unit (IMUs), motion detector, wireless sensor such as BLUETOOTH, WIFI, RFID, or similar sensor, radar sensor, lidar sensor, microphone, acoustic positioning sensor, infrared sensor, magnetic sensor, hall effect sensor, voltage sensor, current sensor, temperature sensor, force sensor, strain sensor, vibration sensor, or the like.

With continued reference to FIG. 1, display device 136 may generate a plurality of registrations matching each frame of a plurality of frames of visual input data such as field of view 136 to a field coordinate system. A “field coordinate system,” as used herein is a coordinate system of the field of view, such as a Cartesian coordinate system a polar coordinate system, or the like; field coordinate system does not depend on a head position of a user or display device 136. In other words, a position of an object within the field coordinate system is static unless the object is moved. Field coordinate system may include a three-dimensional coordinate system. An origin point of field coordinate system may be selected, without limitation, for convenience of calculation, such as selection of a pixel on a frame, such as a first frame as described below which may include without limitation an origin point on a coordinate system of first frame.

With continued reference to FIG. 1, generating plurality of registrations includes defining a first registration of a first frame to the field coordinate system. “Registration” of a frame to a coordinate system, as used in this disclosure, means identifying a location within the coordinate system of each pixel of the frame, either by directly identifying the location of each pixel, and/or by identifying a location of a sufficient number of pixels, such as corner pixels or the like, of the frame to make mathematical determination of location of all other pixels mathematically possible; registration may include identifying coordinates of some excess number of pixels to the minimal number needed to identifying position within the coordinate system, such as identification of one pixel more, twice as many pixels, or ten times as many pixels, where excess pixels may be used to perform error detection and/or correction as described in further detail below. Registration of a frame to field coordinate system may be characterized as a map associating each pixel of a frame, and/or coordinates thereof in a frame coordinate system, to a pixel of field coordinate system. Such mapping may result in a two-dimensional projection of corresponding three-dimensional coordinates on one or more two-dimensional images. First frame may be selected at startup of display device 136, upon entry of a user command indicating that user is ready to begin a tour, that user is facing an entryway of a physical space, and/or that an object of interest is in frame; first frame may be selected as a frame generated when such command is received. Alternatively or additionally, defining the first registration may include detecting a portion of a physical space corresponding to a location in virtual space with which a user interacted previously, determining that the portion of the physical space corresponding to a location in virtual space with which a user interacted previously is centrally located in the first frame, and registering the first frame to the field coordinate system. First frame may include two frames where two frames are captured for stereoscopic images; in this case each such frame may be separately registered, and corresponding subsequent frames may be registered with regard to corresponding original first frame. In the description that follows, it should be assumed that each process described may be performed in parallel on two families or streams of frames forming a stereoscopic image.

With continued reference to FIG. 1, memory 128 may further contain instructions configuring processor 124 to transmit a plurality of rest frames 144 to display device 136, wherein the plurality of rest frames 144 comprise virtually stationary components. “Rest frames,” as described herein, are virtually stationary components that are displayed on display device 132. For example, rest frame may include a home button, a compass, a speed gauge and the like located on a fixed area of display device 136. Rest frame may include a widget, or a visual feature located on a bottom of display device 136. rest frame may reduce passenger discomfort by providing a passenger with a reference frame that is not moving in comparison to field of view 140 displayed on display device 136. Rest frame may include visually represented numerical or character data such as the surrounding temperature of the aircraft, the speed of the aircraft, the city or country the aircraft is flying over, the elevation of the aircraft and the like. Rest frame may further include widgets that may be interacted with by a user. For example, rest frame may include a home button located on a corner screen of display device 136, wherein a user may engage with the home button to navigate various options displayed on display device 136.

With continued reference to FIG. 1, transmitting field of view 140 to display device 136 may further include transmitting field of view 140 to a user interface, the user interface displayed on the display device 136. “User interface” as described herein is a means by which a computing system and a user interact. A user may interact with user interface through the use of input device 104s and software on a computing device 112. A user interface may include a graphical user interface (GUI), command line interface (CLI), menu-driven user interface, touch user interface, voice user interface (VUI), form-based user interface, any combination thereof and the like. In some embodiments, a user may interact with the user interface using a computing device 112 distinct from and communicatively connected to processor 124. For example, a smart phone, smart, tablet, or laptop operated by the passenger on an aircraft. A user interface may include one or more graphical locator and/or cursor facilities allowing a user to interact with graphical models and/or combinations thereof, for instance using a touchscreen, touchpad, mouse, keyboard, and/or other manual data entry device. In an embodiment, user interface may include a graphical user interface. A “graphical user interface” as used herein, is a graphical form of user interface that allows users to interact with electronic devices. In some embodiments, GUI may include icons, menus, other visual indicators, or representations (graphics), audio indicators such as primary notation, and display information and related user controls. A menu may contain a list of choices and may allow users to select one from them. Additionally, or alternatively a home menu may allow a user to return to a previous screen or the like. In some embodiments, information contained in user interface may be directly influenced using graphical control elements such as widgets. A “widget,” as used herein, is a user control element that allows a user to control and change the appearance of elements in the user interface. In this context, a widget may refer to a home button, a menu button, an audio controller icon or to a customized collection of such elements used for a specific function or applications. User interface controls may include software components that a user interacts with through direct manipulation to read or edit information displayed through user interface. Widgets may be used to display lists of similar items, navigate the system using links, tabs, and manipulate data using check boxes, radio boxes, and the like. In some embodiments, user interface may allow a passenger to interact with field of view 140. In a non-limiting example, a passenger may navigate field by changing the perspective shown on display device 136. a passenger may “zoom out” wherein display device 136 may display a larger surrounding area. Similarly, a passenger may zoom out in order to focus the passenger's attention to a specific surrounding area. Passenger may further interact with user interface by altering a brightness on display device 136. Passenger may further interact with user interface by commanding user interface to display various elements such as temperature data, speed data and the like. Passenger may further interact with user interface wherein passenger may interact with a software that allows passenger to access a variety of entertainment software, such as and without limitation, a media player, a video player, a software capable of displaying E-books, and any other entertainment software that may be enjoyed on an aircraft during flight.

With continued reference to FIG. 1, display device 136 may be located on a side of a fuselage of the aircraft. “Side,” for the purposes of this disclosure, may include, a floor, a side wall, a roof, or any other surface within fuselage. In some embodiments, display device 136 may be located on a side wall of an aircraft similar to the positioning of a passenger window on a tube and wing aircraft. In this embodiment, display device 136 may take the place of a passenger window, wherein display device 136 may mimic a surrounding area as through a passenger was peering through a passenger window. In some embodiments, display device 136 may be located on a roof of aircraft wherein display device 136 may mimic a skylight. In some embodiments, displace device may be located an a back of a passenger seat wherein display device 136 is positioned in front of a passenger in a previous row. In some embodiments, display device 136 may be located within a cockpit of aircraft. In some embodiments, display device 136 may be placed in lieu or in addition to flight deck windshields. In this embodiment, a pilot may use display device 136 to navigate aircraft. In some embodiments, display device 136 may contain a transparent display, wherein pilot may use display device 136 both as a window and as a display. In some embodiments, display device 136 may provide a pilot with information surrounding the aircraft such that a pilot may make informed decisions during aerial flight. In some embodiments, device display may be located on an interior wall of an aircraft. In some embodiments, display device 136 may be located on an interior wall of an aircraft, wherein the interior wall is not situated on a side of a fuselage of aircraft. In some embodiments, display device 136 may be located within an aircraft having multiple cabin bays. An aircraft having multiple cabin bays may not have the capabilities to install windows near all of the passenger seats. For example, an aircraft having 3 cabin bays, wherein a first cabin bay is located on a right side of aircraft, the second cabin bay is located on a left side of aircraft and a third cabin bay located within a middle of the aircraft wherein the third cabin is located between the first and second cabin bay, the third cabin may not have access to windows due to its position within aircraft. In such a layout, display device 136 may be situated on walls of third cabin bay in lieu of windows. In some embodiments, device display be located in front of, or on the side of a bulkhead seat on the aircraft. In some embodiments, display device 136 may be located on a wall of an interior cabin. An “interior cabin,” for the purposes of this disclosure is a cabin of an aircraft that does not border an exterior wall. “Bulkhead seat” as described herein is a seat located against a wall, wherein the wall is used as a diving area between different portion of an aircraft. For example, the wall may be used as a dividing area between the passenger seat and crew areas, galleys or other cabins within an aircraft.

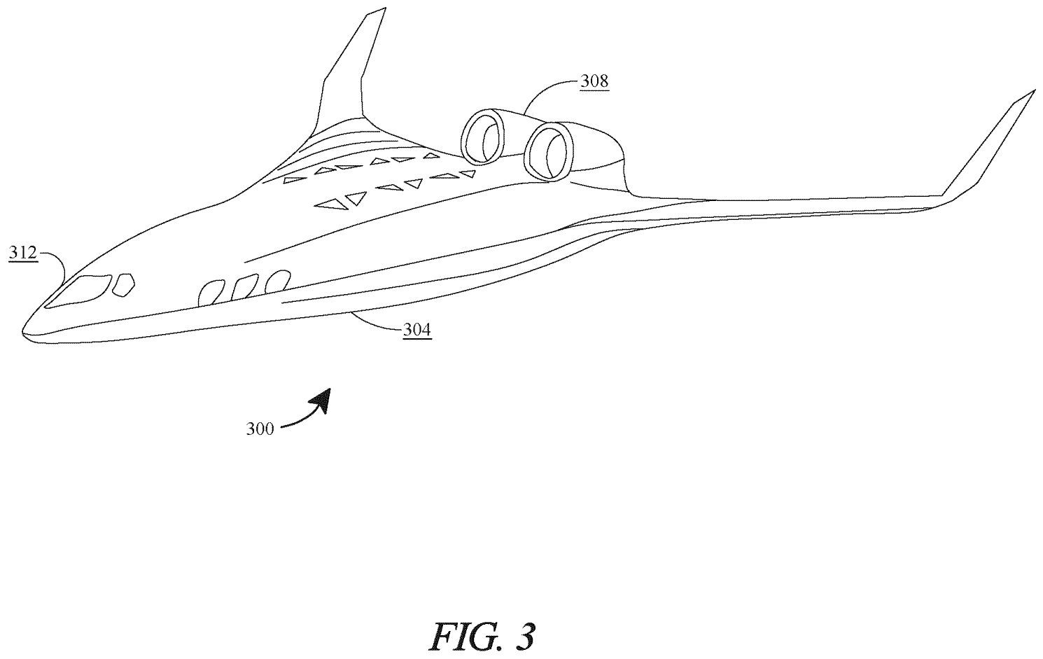

With continued reference to FIG. 1, apparatus 100 may further include a blended wing body aircraft, wherein display device 136 is located within blended wing body aircraft. A “BWB” also known as a “blended body” or a “hybrid wing body” (HWB), is a fixed-wing aircraft body having no clear or abrupt demarcation between the wings and a main body of the aircraft along a leading edge of the aircraft. For example, a BWB aircraft may have distinct wings and body structures, which are smoothly blended together with no clear dividing line or boundary feature between the wings and the fuselage. This contrasts with a flying wing, which has no distinct fuselage, and a lifting body, which has no distinct wings. A BWB design may or may not be tailless. One potential advantage of a BWB may be to reduce wetted area and any accompanying drag associated with a tube and wing wing-body junction. In some cases, a BWB may also have a wide airfoil-shaped body, allowing entire aircraft to generate lift and thereby facilitate reduction in size and/or drag of wings. In some cases, BWB may be understood as a hybrid shape that resembles a flying wing, but also incorporates features from tube and wing aircraft. In some cases, this combination may offer several advantages over tube-and-wing airframes. In some cases, a BWB airframe may help to increase fuel economy and create larger payload (cargo or passenger) volumes within BWB. BWB may allow for advantageous interior designs. For instance, cargo can be loaded and/or passengers can board from the front or rear of the aircraft. A cargo or passenger area may be distributed across a relatively wide (when compared to tube-wing aircraft) fuselage, providing a large usable volume. In some embodiments, passengers seated within an interior of aircraft, real-time video at every seat can take place of window seats. As described in this disclosure “main body” is a portion of BWB that is capable of holding passengers and/or cargo. In some embodiments, main body may refer to a fuselage of the aircraft. In some embodiments, main body may be contrasted to a tube and wing body aircraft, wherein the aircraft tube and wing body contains a clear transition between the fuselage and the aircraft wing. Further disclosure about a fuselage is described in detail below, for example with reference to FIG. 3.

Referring now to FIG. 2, an exemplary embodiment of a display device 204 located on an aircraft is illustrated. Aircraft 200 may include any aircraft, such as and without limitation, a blended wing body aircraft as described in this disclosure, a tube and wing aircraft, a helicopter, or any other flying vehicles. As Shown in FIG. 2, display device may be located on a wall 208 of aircraft 200. Similar to a passenger aircraft in which windows may be positioned along the sides of aircraft 200, display device 208 may be situated in a similar location similar to that of passenger windows. It is to be noted that display device may be located anywhere within passenger cabin. For example, display device may be located behind a passenger seat 212, wherein a passenger in a previous row may utilize display device 208. Similarly, display device be located on a roof of passenger cabin within aircraft 200. Display device 208 may take the shape of a conventional passenger window in order to mimic the effect of a window on aircraft 200. Display device may further take any form or shape. Display device 208 may be consistent with any display device as described in this disclosure.

Referring to FIG. 3, an exemplary blended wing aircraft 300 is illustrated. Aircraft 300 may include a blended wing body 304. For the purposes of this disclosure, a “blended wing body aircraft” is an aircraft having a blended wing body. As used in this disclosure, A “blended wing body” (BWB), also known as a “blended body” or a “hybrid wing body” (HWB), is a fixed-wing aircraft body having no clear or abrupt demarcation between wings and a main body of the aircraft along a leading edge of the aircraft. For example, a BWB 304 aircraft may have distinct wing and body structures, which are smoothly blended together with no clear dividing line or boundary feature between wing and fuselage. This contrasts with a flying wing, which has no distinct fuselage, and a lifting body, which has no distinct wings. A BWB 304 design may or may not be tailless. One potential advantage of a BWB 304 may be to reduce wetted area and any accompanying drag associated with a conventional wing-body junction. In some cases, a BWB 304 may also have a wide airfoil-shaped body, allowing entire aircraft to generate lift and thereby facilitate reduction in size and/or drag of wings. In some cases, a BWB 304 may be understood as a hybrid shape that resembles a flying wing, but also incorporates features from conventional aircraft. In some cases, this combination may offer several advantages over conventional tube-and-wing airframes. In some cases, a BWB airframe 304 may help to increase fuel economy and create larger payload (cargo or passenger) volumes within the BWB. BWB 304 may allow for advantageous interior designs. For instance, cargo can be loaded and/or passengers can board from the front or rear of the aircraft. A cargo or passenger area may be distributed across a relatively wide (when compared to conventional tube-wing aircraft) fuselage, providing a large usable volume. In some embodiments, passengers seated within an interior of aircraft, real-time video at every seat can take place of window seats.

With continued reference to FIG. 3, BWB 304 of aircraft 300 may include a nose portion. A “nose portion,” for the purposes of this disclosure, refers to any portion of aircraft 300 forward of the aircraft's fuselage 316. Nose portion may comprise a cockpit (for manned aircraft), canopy, aerodynamic fairings, windshield, and/or any structural elements required to support mechanical loads. Nose portion may also include pilot seats, control interfaces, gages, displays, inceptor sticks, throttle controls, collective pitch controls, and/or communication equipment, to name a few. Nose portion may comprise a swing nose configuration. A swing nose may be characterized by an ability of the nose to move, manually or automatedly, into a differing orientation than its flight orientation to provide an opening for loading a payload into aircraft fuselage from the front of the aircraft. Nose portion may be configured to open in a plurality of orientations and directions.

With continued reference to FIG. 3, BWB 304 may include at least a structural component of aircraft 300. Structural components may provide physical stability during an entirety of an aircraft's 300 flight envelope, while on ground, and during normal operation Structural components may comprise struts, beams, formers, stringers, longerons, interstitials, ribs, structural skin, doublers, straps, spars, or panels, to name a few. Structural components may also comprise pillars. In some cases, for the purpose of aircraft cockpits comprising windows/windshields, pillars may include vertical or near vertical supports around a window configured to provide extra stability around weak points in a vehicle's structure, such as an opening where a window is installed. Where multiple pillars are disposed in an aircraft's 300 structure, they may be so named A, B, C, and so on named from nose to tail. Pillars, like any structural element, may be disposed a distance away from each other, along an exterior of aircraft 300 and BWB 304. Depending on manufacturing method of BWB 304, pillars may be integral to frame and skin, comprised entirely of internal framing, or alternatively, may be only integral to structural skin elements. Structural skin will be discussed in greater detail below.

With continued reference to FIG. 3, BWB 304 may include a plurality of materials, alone or in combination, in its construction. At least a BWB 304, in an illustrative embodiment may include a welded steel tube frame further configured to form a general shape of a nose corresponding to an arrangement of steel tubes. Steel may include any of a plurality of alloyed metals, including but not limited to, a varying amount of manganese, nickel, copper, molybdenum, silicon, and/or aluminum, to name a few. Welded steel tubes may be covered in any of a plurality of materials suitable for aircraft skin. Some of these may include carbon fiber, fiberglass panels, cloth-like materials, aluminum sheeting, or the like. BWB 304 may comprise aluminum tubing mechanically coupled in various and orientations. Mechanical fastening of aluminum members (whether pure aluminum or alloys) may comprise temporary or permanent mechanical fasteners appreciable by one of ordinary skill in the art including, but not limited to, screws, nuts and bolts, anchors, clips, welding, brazing, crimping, nails, blind rivets, pull-through rivets, pins, dowels, snap-fits, clamps, and the like. BWB 304 may additionally or alternatively use wood or another suitably strong yet light material for an internal structure.

With continued reference to FIG. 3, aircraft 300 may include monocoque or semi-monocoque construction. BWB 304 may include carbon fiber. Carbon fiber may include carbon fiber reinforced polymer, carbon fiber reinforced plastic, or carbon fiber reinforced thermoplastic (e.g., CFRP, CRP, CFRTP, carbon composite, or just carbon, depending on industry). “Carbon fiber,” as used in this disclosure, is a composite material including a polymer reinforced with carbon. In general, carbon fiber composites consist of two parts, a matrix and a reinforcement. In carbon fiber reinforced plastic, the carbon fiber constitutes the reinforcement, which provides strength. The matrix can include a polymer resin, such as epoxy, to bind reinforcements together. Such reinforcement achieves an increase in CFRP's strength and rigidity, measured by stress and elastic modulus, respectively. In embodiments, carbon fibers themselves can each comprise a diameter between 5-10 micrometers and include a high percentage (i.e. above 85%) of carbon atoms. A person of ordinary skill in the art will appreciate that the advantages of carbon fibers include high stiffness, high tensile strength, low weight, high chemical resistance, high temperature tolerance, and low thermal expansion. According to embodiments, carbon fibers may be combined with other materials to form a composite, when permeated with plastic resin and baked, carbon fiber reinforced polymer becomes extremely rigid. Rigidity may be considered analogous to stiffness which may be measured using Young's Modulus. Rigidity may be defined as a force necessary to bend and/or flex a material and/or structure to a given degree. For example, ceramics have high rigidity, which can be visualized by shattering before bending. In embodiments, carbon fibers may additionally, or alternatively, be composited with other materials like graphite to form reinforced carbon-carbon composites, which include high heat tolerances over 3000° C. A person of skill in the art will further appreciate that aerospace applications may require high-strength, low-weight, high heat resistance materials in a plurality of roles, such as without limitation fuselages, fairings, control surfaces, and structures, among others.

With continued reference to FIG. 3, BWB 304 may include at least a fuselage. A “fuselage,” for the purposes of this disclosure, refers to a main body of an aircraft 300, or in other words, an entirety of the aircraft 300 except for nose, wings, empennage, nacelles, and control surfaces. In some cases, fuselage may contain an aircraft's payload. At least a fuselage may comprise structural components that physically support a shape and structure of an aircraft 300. Structural components may take a plurality of forms, alone or in combination with other types. Structural components vary depending on construction type of aircraft 300 and specifically, fuselage. A fuselage 313 may include a truss structure. A truss structure may be used with a lightweight aircraft. A truss structure may include welded steel tube trusses. A “truss,” as used in this disclosure, is an assembly of beams that create a rigid structure, for example without limitation including combinations of triangles to create three-dimensional shapes. A truss structure may include wood construction in place of steel tubes, or a combination thereof. In some embodiments, structural components can comprise steel tubes and/or wood beams. An aircraft skin may be layered over a body shape constructed by trusses. Aircraft skin may comprise a plurality of materials such as plywood sheets, aluminum, fiberglass, and/or carbon fiber.

With continued reference to FIG. 3, in embodiments, at least a fuselage may comprise geodesic construction. Geodesic structural elements may include stringers wound about formers (which may be alternatively called station frames) in opposing spiral directions. A “stringer,” for the purposes of this disclosure is a general structural element that includes a long, thin, and rigid strip of metal or wood that is mechanically coupled to and spans the distance from, station frame to station frame to create an internal skeleton on which to mechanically couple aircraft skin. A former (or station frame) can include a rigid structural element that is disposed along a length of an interior of a fuselage orthogonal to a longitudinal (nose to tail) axis of aircraft 300. In some cases, a former forms a general shape of at least a fuselage. A former may include differing cross-sectional shapes at differing locations along a fuselage, as the former is a structural component that informs an overall shape of the fuselage. In embodiments, aircraft skin can be anchored to formers and strings such that an outer mold line of volume encapsulated by the formers and stringers comprises a same shape as aircraft 300 when installed. In other words, former(s) may form a fuselage's ribs, and stringers may form interstitials between the ribs. A spiral orientation of stringers about formers may provide uniform robustness at any point on an aircraft fuselage such that if a portion sustains damage, another portion may remain largely unaffected. Aircraft skin may be mechanically coupled to underlying stringers and formers and may interact with a fluid, such as air, to generate lift and perform maneuvers.

With continued reference to FIG. 3, according to some embodiments, a fuselage can comprise monocoque construction. Monocoque construction can include a primary structure that forms a shell (or skin in an aircraft's case) and supports physical loads. Monocoque fuselages are fuselages in which the aircraft skin or shell may also include a primary structure. In monocoque construction aircraft skin would support tensile and compressive loads within itself and true monocoque aircraft can be further characterized by an absence of internal structural elements. Aircraft skin in this construction method may be rigid and can sustain its shape with substantially no structural assistance form underlying skeleton-like elements. Monocoque fuselage may include aircraft skin made from plywood layered in varying grain directions, epoxy-impregnated fiberglass, carbon fiber, or any combination thereof.

With continued reference to FIG. 3, according to some embodiments, a fuselage may include a semi-monocoque construction. Semi-monocoque construction, as used in this disclosure, is used interchangeably with partially monocoque construction, discussed above. In semi-monocoque construction, a fuselage may derive some structural support from stressed aircraft skin and some structural support from underlying frame structure made of structural components. Formers or station frames can be seen running transverse to a long axis of fuselage with circular cutouts which may be used in real-world manufacturing for weight savings and for routing of electrical harnesses and other modern on-board systems. In a semi-monocoque construction, stringers may be thin, long strips of material that run parallel to a fuselage's long axis. Stringers can be mechanically coupled to formers permanently, such as with rivets. Aircraft skin can be mechanically coupled to stringers and formers permanently, such as by rivets as well. A person of ordinary skill in the art will appreciate that there are numerous methods for mechanical fastening of the aforementioned components like screws, nails, dowels, pins, anchors, adhesives like glue or epoxy, or bolts and nuts, to name a few. According to some embodiments, a subset of semi-monocoque construction may be unibody construction. Unibody, which is short for “unitized body” or alternatively “unitary construction”, vehicles are characterized by a construction in which body, floor plan, and chassis form a single structure, for example an automobile. In the aircraft world, a unibody may include internal structural elements, like formers and stringers, constructed in one piece, integral to an aircraft skin. In some cases, stringers and formers may account for the bulk of any aircraft structure (excluding monocoque construction). Stringers and formers can be arranged in a plurality of orientations depending on aircraft operation and materials. Stringers may be arranged to carry axial (tensile or compressive), shear, bending or torsion forces throughout their overall structure. Due to their coupling to aircraft skin, aerodynamic forces exerted on aircraft skin may be transferred to stringers. Location of said stringers greatly informs type of forces and loads applied to each and every stringer, all of which may be accounted for through design processes including, material selection, cross-sectional area, and mechanical coupling methods of each member. Similar methods may be performed for former assessment and design. In general, formers may be significantly larger in cross-sectional area and thickness, depending on location, than stringers. Both stringers and formers may comprise aluminum, aluminum alloys, graphite epoxy composite, steel alloys, titanium, or an undisclosed material alone or in combination.

With continued reference to FIG. 3, in some cases, a primary purpose for a substructure of a semi-monocoque structure is to stabilize a skin. Typically, aircraft structure is required to have a very light weight and as a result, in some cases, aircraft skin may be very thin. In some cases, unless supported, this thin skin structure may tend to buckle and/or cripple under compressive and/or shear loads. In some cases, underlying structure may be primarily configured to stabilize skins. For example, in an exemplary conventional airliner, wing structure is an airfoil-shaped box with truncated nose and aft triangle; without stabilizing substructure, in some cases, this box would buckle upper skin of the wing and the upper skin would also collapse into the lower skin under bending loads. In some cases, deformations are prevented with ribs that support stringers which stabilize the skin. Fuselages are similar with bulkheads or frames, and stringers.

With continued reference to FIG. 3, in some embodiments, another common structural form is sandwich structure. As used in this disclosure, “sandwich structure” includes a skin structure having an inner and outer skin separated and stabilized by a core material. In some cases, sandwich structure may additionally include some number of ribs or frames. In some cases, sandwich structure may include metal, polymer, and/or composite. In some cases, core material may include honeycomb, foam plastic, and/or end-grain balsa wood. In some cases, sandwich structure can be popular on composite light airplanes, such as gliders and powered light planes. In some cases, sandwich structure may not use stringers, and sandwich structure may allow number of ribs or frames to be reduced, for instance in comparison with a semi-monocoque structure. In some cases, sandwich structure may be suitable for smaller, possibly unmanned, unpressurized blended wing body aircraft.

With continued reference to FIG. 3, stressed skin, when used in semi-monocoque construction, may bear partial, yet significant, load. In other words, an internal structure, whether it be a frame of welded tubes, formers and stringers, or some combination, is not sufficiently strong enough by design to bear all loads. The concept of stressed skin is applied in monocoque and semi-monocoque construction methods of at least a fuselage and/or BWB 304. In some cases, monocoque may be considered to include substantially only structural skin, and in that sense, aircraft skin undergoes stress by applied aerodynamic fluids imparted by fluid. Stress as used in continuum mechanics can be described in pound-force per square inch (lbf/in³) or Pascals (Pa). In semi-monocoque construction stressed skin bears part of aerodynamic loads and additionally imparts force on an underlying structure of stringers and formers.

With continued reference to FIG. 3, a fuselage may include an interior cavity. An interior cavity may include a volumetric space configurable to house passenger seats and/or cargo. An interior cavity may be configured to include receptacles for fuel tanks, batteries, fuel cells, or other energy sources as described herein. In some cases, a post may be supporting a floor (i.e., deck), or in other words a surface on which a passenger, operator, passenger, payload, or other object would rest on due to gravity when within an aircraft 300 is in its level flight orientation or sitting on ground. A post may act similarly to stringer in that it is configured to support axial loads in compression due to a load being applied parallel to its axis due to, for example, a heavy object being placed on a floor of aircraft 300. A beam may be disposed in or on any portion a fuselage that requires additional bracing, specifically when disposed transverse to another structural element, like a post, that would benefit from support in that direction, opposing applied force. A beam may be disposed in a plurality of locations and orientations within a fuselage as necessitated by operational and constructional requirements.

With continued reference to FIG. 3, aircraft 300 may include at least a flight component 308. A flight component 308 may be consistent with any description of a flight component described in this disclosure, such as without limitation propulsors, control surfaces, rotors, paddle wheels, engines, propellers, wings, winglets, or the like. For the purposes of this disclosure, at least a “flight component” is at least one element of an aircraft 300 configured to manipulate a fluid medium such as air to propel, control, or maneuver an aircraft. In nonlimiting examples, at least a flight component may include a rotor mechanically connected to a rotor shaft of an electric motor further mechanically affixed to at least a portion of aircraft 300. In some embodiments, at least a flight component 308 may include a propulsor, for example a rotor attached to an electric motor configured to produce shaft torque and in turn, create thrust. As used in this disclosure, an “electric motor” is an electrical machine that converts electric energy into mechanical work.

With continued reference to FIG. 3, for the purposes of this disclosure, “torque”, is a twisting force that tends to cause rotation. Torque may be considered an effort and a rotational analogue to linear force. A magnitude of torque of a rigid body may depend on three quantities: a force applied, a lever arm vector connecting a point about which the torque is being measured to a point of force application, and an angle between the force and the lever arm vector. A force applied perpendicularly to a lever multiplied by its distance from the lever's fulcrum (the length of the lever arm) is its torque. A force of three newtons applied two meters from the fulcrum, for example, exerts the same torque as a force of one newton applied six meters from the fulcrum. In some cases, direction of a torque can be determined by using a right-hand grip rule which states: if fingers of right hand are curled from a direction of lever arm to direction of force, then thumb points in a direction of the torque. One of ordinary skill in the art would appreciate that torque may be represented as a vector, consistent with this disclosure, and therefore may include a magnitude and a direction. “Torque” and “moment” are used interchangeably within this disclosure. Any torque command or signal within this disclosure may include at least the steady state torque to achieve the torque output to at least a propulsor.

With continued reference to FIG. 3, at least a flight component may be one or more devices configured to affect aircraft's 300 attitude. “Attitude”, for the purposes of this disclosure, is the relative orientation of a body, in this case aircraft 300, as compared to earth's surface or any other reference point and/or coordinate system. In some cases, attitude may be displayed to pilots, personnel, remote users, or one or more computing devices in an attitude indicator, such as without limitation a visual representation of a horizon and its relative orientation to aircraft 300. A plurality of attitude datums may indicate one or more measurements relative to an aircraft's pitch, roll, yaw, or throttle compared to a relative starting point. One or more sensors may measure or detect an aircraft's 300 attitude and establish one or more attitude datums. An “attitude datum”, for the purposes of this disclosure, refers to at least an element of data identifying an attitude of an aircraft 300.

With continued reference to FIG. 3, in some cases, aircraft 300 may include one or more of an angle of attack sensor and a yaw sensor. In some embodiments, one or more of an angle of attack sensor and a yaw sensor may include a vane (e.g., wind vane). In some cases, vane may include a protrusion on a pivot with an aft tail. The protrusion may be configured to rotate about pivot to maintain zero tail angle of attack. In some cases, pivot may turn an electronic device that reports one or more of angle of attack and/or yaw, depending on, for example, orientation of the pivot and tail. Alternatively or additionally, in some cases, one or more of angle of attack sensor and/or yaw sensor may include a plurality of pressure ports located in selected locations, with pressure sensors located at each pressure port. In some cases, differential pressure between pressure ports can be used to estimate angle of attack and/or yaw.

With continued reference to FIG. 3, in some cases, aircraft 300 may include at least a pilot control. As used in this disclosure, a “pilot control,” is an interface device that allows an operator, human or machine, to control a flight component of an aircraft. Pilot control may be communicatively connected to any other component presented in aircraft 300, the communicative connection may include redundant connections configured to safeguard against single-point failure. In some cases, a plurality of attitude datums may indicate a pilot's instruction to change heading and/or trim of an aircraft 300. Pilot input may indicate a pilot's instruction to change an aircraft's pitch, roll, yaw, throttle, and/or any combination thereof. Aircraft trajectory may be manipulated by one or more control surfaces and propulsors working alone or in tandem consistent with the entirety of this disclosure. “Pitch”, for the purposes of this disclosure refers to an aircraft's angle of attack, that is a difference between a plane including at least a portion of both wings of the aircraft running nose to tail and a horizontal flight trajectory. For example, an aircraft may pitch “up” when its nose is angled upward compared to horizontal flight, as in a climb maneuver. In another example, an aircraft may pitch “down”, when its nose is angled downward compared to horizontal flight, like in a dive maneuver. In some cases, angle of attack may not be used as an input, for instance pilot input, to any system disclosed herein; in such circumstances proxies may be used such as pilot controls, remote controls, or sensor levels, such as true airspeed sensors, pitot tubes, pneumatic/hydraulic sensors, and the like. “Roll” for the purposes of this disclosure, refers to an aircraft's position about its longitudinal axis, that is to say that when an aircraft rotates about its axis from its tail to its nose, and one side rolls upward, as in a banking maneuver. “Yaw”, for the purposes of this disclosure, refers to an aircraft's turn angle, when an aircraft rotates about an imaginary vertical axis intersecting center of earth and aircraft 300. “Throttle”, for the purposes of this disclosure, refers to an aircraft outputting an amount of thrust from a propulsor. In context of a pilot input, throttle may refer to a pilot's input to increase or decrease thrust produced by at least a propulsor. Flight components 308 may receive and/or transmit signals, for example an aircraft command signal. Aircraft command signal may include any signal described in this disclosure, such as without limitation electrical signal, optical signal, pneumatic signal, hydraulic signal, and/or mechanical signal. In some cases, an aircraft command may be a function of a signal from a pilot control. In some cases, an aircraft command may include or be determined as a function of a pilot command. For example, aircraft commands may be determined as a function of a mechanical movement of a throttle. Signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. Pilot control may include circuitry, computing devices, electronic components or a combination thereof that translates pilot input into a signal configured to be transmitted to another electronic component. In some cases, a plurality of attitude commands may be determined as a function of an input to a pilot control. A plurality of attitude commands may include a total attitude command datum, such as a combination of attitude adjustments represented by one or a certain number of combinatorial datums. A plurality of attitude commands may include individual attitude datums representing total or relative change in attitude measurements relative to pitch, roll, yaw, and throttle.

With continued reference to FIG. 3, in some embodiments, pilot control may include at least a sensor. As used in this disclosure, a “sensor” is a device that detects a phenomenon. In some cases, a sensor may detect a phenomenon and transmit a signal that is representative of the phenomenon. At least a sensor may include, torque sensor, gyroscope, accelerometer, magnetometer, inertial measurement unit (IMU), pressure sensor, force sensor, proximity sensor, displacement sensor, vibration sensor, among others. At least a sensor may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor. For the purposes of the disclosure, a “torque datum” is one or more elements of data representing one or more parameters detailing power output by one or more propulsors, flight components, or other elements of an electric aircraft. A torque datum may indicate the torque output of at least a flight component 308. At least a flight component 308 may include any propulsor as described herein. In embodiment, at least a flight component 308 may include an electric motor, a propeller, a jet engine, a paddle wheel, a rotor, turbine, or any other mechanism configured to manipulate a fluid medium to propel an aircraft as described herein. an embodiment of at least a sensor may include or be included in, a sensor suite. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In a non-limiting example, there may be four independent sensors housed in and/or on battery pack measuring temperature, electrical characteristic such as voltage, amperage, resistance, or impedance, or any other parameters and/or quantities as described in this disclosure. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of a battery management system and/or user to detect phenomenon is maintained and in a non-limiting example, a user alter aircraft usage pursuant to sensor readings.

With continued reference to FIG. 3, at least a sensor may include a moisture sensor. “Moisture”, as used in this disclosure, is the presence of water, this may include vaporized water in air, condensation on the surfaces of objects, or concentrations of liquid water. Moisture may include humidity. “Humidity”, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. A moisture sensor may be psychrometer. A moisture sensor may be a hygrometer. A moisture sensor may be configured to act as or include a humidistat. A “humidistat”, for the purposes of this disclosure, is a humidity-triggered switch, often used to control another electronic device. A moisture sensor may use capacitance to measure relative humidity and include in itself, or as an external component, include a device to convert relative humidity measurements to absolute humidity measurements. “Capacitance”, for the purposes of this disclosure, is the ability of a system to store an electric charge, in this case the system is a parcel of air which may be near, adjacent to, or above a battery cell.

With continued reference to FIG. 3, at least a sensor may include electrical sensors. An electrical sensor may be configured to measure voltage across a component, electrical current through a component, and resistance of a component. Electrical sensors may include separate sensors to measure each of the previously disclosed electrical characteristics such as voltmeter, ammeter, and ohmmeter, respectively. One or more sensors may be communicatively coupled to at least a pilot control, the manipulation of which, may constitute at least an aircraft command. Signals may include electrical, electromagnetic, visual, audio, radio waves, or another undisclosed signal type alone or in combination. At least a sensor communicatively connected to at least a pilot control may include a sensor disposed on, near, around or within at least pilot control. At least a sensor may include a motion sensor. “Motion sensor”, for the purposes of this disclosure refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. At least a sensor may include, torque sensor, gyroscope, accelerometer, torque sensor, magnetometer, inertial measurement unit (IMU), pressure sensor, force sensor, proximity sensor, displacement sensor, vibration sensor, among others. At least a sensor may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings.

With continued reference to FIG. 3, at least a flight component 308 may include wings, empennages, nacelles, control surfaces, fuselages, and landing gear, among others, to name a few. In embodiments, an empennage may be disposed at the aftmost point of an aircraft body 304. Empennage may comprise a tail of aircraft 300, further comprising rudders, vertical stabilizers, horizontal stabilizers, stabilators, elevators, trim tabs, among others. At least a portion of empennage may be manipulated directly or indirectly by pilot commands to impart control forces on a fluid in which the aircraft 300 is flying. Manipulation of these empennage control surfaces may, in part, change an aircraft's heading in pitch, roll, and yaw. Wings comprise may include structures which include airfoils configured to create a pressure differential resulting in lift. Wings are generally disposed on a left and right side of aircraft 300 symmetrically, at a point between nose and empennage. Wings may comprise a plurality of geometries in planform view, swept swing, tapered, variable wing, triangular, oblong, elliptical, square, among others. Wings may be blended into the body of the aircraft such as in a BWB 304 aircraft 300 where no strong delineation of body and wing exists. A wing's cross section geometry may comprise an airfoil. An “airfoil” as used in this disclosure, is a shape specifically designed such that a fluid flowing on opposing sides of it exert differing levels of pressure against the airfoil. In embodiments, a bottom surface of an aircraft can be configured to generate a greater pressure than does a top surface, resulting in lift. A wing may comprise differing and/or similar cross-sectional geometries over its cord length, e.g., length from wing tip to where wing meets the aircraft's body. One or more wings may be symmetrical about an aircraft's longitudinal plane, which comprises a longitudinal or roll axis reaching down a center of the aircraft through the nose and empennage, and the aircraft's yaw axis. In some cases, wings may comprise controls surfaces configured to be commanded by a pilot and/or autopilot to change a wing's geometry and therefore its interaction with a fluid medium. Flight component 308 may include control surfaces. Control surfaces may include without limitation flaps, ailerons, tabs, spoilers, and slats, among others. In some cases, control surfaces may be disposed on wings in a plurality of locations and arrangements. In some cases, control surfaces may be disposed at leading and/or trailing edges of wings, and may be configured to deflect up, down, forward, aft, or any combination thereof.

In some cases, flight component 308 may include a winglet. For the purposes of this disclosure, a “winglet” is a flight component configured to manipulate a fluid medium and is mechanically attached to a wing or aircraft and may alternatively called a “wingtip device.” Wingtip devices may be used to improve efficiency of fixed-wing aircraft by reducing drag. Although there are several types of wingtip devices which function in different manners, their intended effect may be to reduce an aircraft's drag by partial recovery of tip vortex energy. Wingtip devices can also improve aircraft handling characteristics and enhance safety for aircraft 300. Such devices increase an effective aspect ratio of a wing without greatly increasing wingspan. Extending wingspan may lower lift-induced drag but would increase parasitic drag and would require boosting the strength and weight of the wing. As a result, according to some aeronautic design equations, a maximum wingspan made be determined above which no net benefit exits from further increased span. There may also be operational considerations that limit the allowable wingspan (e.g., available width at airport gates).

Wingtip devices, in some cases, may increase lift generated at wingtip (by smoothing airflow across an upper wing near the wingtip) and reduce lift-induced drag caused by wingtip vortices, thereby improving a lift-to-drag ratio. This increases fuel efficiency in powered aircraft and increases cross-country speed in gliders, in both cases increasing range. U.S. Air Force studies indicate that a given improvement in fuel efficiency correlates directly and causally with increase in an aircraft's lift-to-drag ratio. The term “winglet” has previously been used to describe an additional lifting surface on an aircraft, like a short section between wheels on fixed undercarriage. An upward angle (i.e., cant) of a winglet, its inward or outward angle (i.e, toe), as well as its size and shape are selectable design parameters which may be chosen for correct performance in a given application. A wingtip vortex, which rotates around from below a wing, strikes a cambered surface of a winglet, generating a force that angles inward and slightly forward. A winglet's relation to a wingtip vortex may be considered analogous to sailboat sails when sailing windward (i.e., close-hauled). Similar to the close-hauled sailboat's sails, winglets may convert some of what would otherwise—be wasted energy in a wingtip vortex to an apparent thrust. This small contribution can be worthwhile over the aircraft's lifetime. Another potential benefit of winglets is that they may reduce an intensity of wake vortices. Wake vortices may trail behind an aircraft 300 and pose a hazard to other aircraft. Minimum spacing requirements between aircraft at airports are largely dictated by hazards, like those from wake vortices. Aircraft are classified by weight (e.g., “Light,” “Heavy,” and the like) often base upon vortex strength, which grows with an aircraft's lift coefficient. Thus, associated turbulence is greatest at low speed and high weight, which may be produced at high angle of attack near airports. Winglets and wingtip fences may also increase efficiency by reducing vortex interference with laminar airflow near wingtips, by moving a confluence of low-pressure air (over wing) and high-pressure air (under wing) away from a surface of the wing. Wingtip vortices create turbulence, which may originate at a leading edge of a wingtip and propagate backwards and inboard. This turbulence may delaminate airflow over a small triangular section of an outboard wing, thereby frustrating lift in that area. A fence/winglet drives an area where a vortex forms upward away from a wing surface, as the resulting vortex is repositioned to a top tip of the winglet.

With continued reference to FIG. 3, aircraft 300 may include an energy source. Energy source may include any device providing energy to at least a flight component 308, for example at least a propulsors. Energy source may include, without limitation, a generator, a photovoltaic device, a fuel cell such as a hydrogen fuel cell, direct methanol fuel cell, and/or solid oxide fuel cell, or an electric energy storage device; electric energy storage device may include without limitation a battery, a capacitor, and/or inductor. The energy source and/or energy storage device may include at least a battery, battery cell, and/or a plurality of battery cells connected in series, in parallel, or in a combination of series and parallel connections such as series connections into modules that are connected in parallel with other like modules. Battery and/or battery cell may include, without limitation, Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode. In embodiments, the energy source may be used to provide electrical power to an electric or hybrid propulsor during moments requiring high rates of power output, including without limitation takeoff, landing, thermal de-icing and situations requiring greater power output for reasons of stability, such as high turbulence situations. In some cases, battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. A person of ordinary skill in the art, upon reviewing the entirety of this disclosure, will be aware of various devices of components that may be used as an energy source.

With continued reference to FIG. 3, in further nonlimiting embodiments, an energy source may include a fuel store. As used in this disclosure, a “fuel store” is an aircraft component configured to store a fuel. In some cases, a fuel store may include a fuel tank. Fuel may include a liquid fuel, a gaseous fluid, a solid fuel, and fluid fuel, a plasma fuel, and the like. As used in this disclosure, a “fuel” may include any substance that stores energy. Exemplary non-limiting fuels include hydrocarbon fuels, petroleum-based fuels, synthetic fuels, chemical fuels, Jet fuels (e.g., Jet-A fuel, Jet-B fuel, and the like), kerosene-based fuel, gasoline-based fuel, an electrochemical-based fuel (e.g., lithium-ion battery), a hydrogen-based fuel, natural gas-based fuel, and the like. As described in greater detail below fuel store may be located substantially within blended wing body 304 of aircraft 300, for example without limitation within a wing portion 313 of blended wing body 308. Aviation fuels may include petroleum-based fuels, or petroleum and synthetic fuel blends, used to power aircraft 300. In some cases, aviation fuels may have more stringent requirements than fuels used for ground use, such as heating and road transport. Aviation fuels may contain additives to enhance or maintain properties important to fuel performance or handling. Fuel may be kerosene-based (JP-8 and Jet A-1), for example for gas turbine-powered aircraft. Piston-engine aircraft may use gasoline-based fuels and/or kerosene-based fuels (for example for Diesel engines). In some cases, specific energy may be considered an important criterion in selecting fuel for an aircraft 300. Liquid fuel may include Jet-A. Presently Jet-A powers modern commercial airliners and is a mix of extremely refined kerosene and burns at temperatures at or above 49° C. (130° F.). Kerosene-based fuel has a much higher flash point than gasoline-based fuel, meaning that it requires significantly higher temperature to ignite.

With continued reference to FIG. 3, modular aircraft 300 may include an energy source which may include a fuel cell. As used in this disclosure, a “fuel cell” is an electrochemical device that combines a fuel and an oxidizing agent to create electricity. In some cases, fuel cells are different from most batteries in requiring a continuous source of fuel and oxygen (usually from air) to sustain the chemical reaction, whereas in a battery the chemical energy comes from metals and their ions or oxides that are commonly already present in the battery, except in flow batteries. Fuel cells can produce electricity continuously for as long as fuel and oxygen are supplied.

With continued reference to FIG. 3, in some embodiments, fuel cells may consist of different types. Commonly a fuel cell consists of an anode, a cathode, and an electrolyte that allows ions, often positively charged hydrogen ions (protons), to move between two sides of the fuel cell. At anode, a catalyst causes fuel to undergo oxidation reactions that generate ions (often positively charged hydrogen ions) and electrons. Ions move from anode to cathode through electrolyte. Concurrently, electrons may flow from anode to cathode through an external circuit, producing direct current electricity. At cathode, another catalyst causes ions, electrons, and oxygen to react, forming water and possibly other products. Fuel cells may be classified by type of electrolyte used and by difference in startup time ranging from 3 second for proton-exchange membrane fuel cells (PEM fuel cells, or PEMFC) to 10 minutes for solid oxide fuel cells (SOFC). In some cases, energy source may include a related technology, such as flow batteries. Within a flow battery fuel can be regenerated by recharging. Individual fuel cells produce relatively small electrical potentials, about 0.7 volts. Therefore, in some cases, fuel cells may be “stacked”, or placed in series, to create sufficient voltage to meet an application's requirements. In addition to electricity, fuel cells may produce water, heat and, depending on the fuel source, very small amounts of nitrogen dioxide and other emissions. Energy efficiency of a fuel cell is generally between 40 and 90%.

Fuel cell may include an electrolyte. In some cases, electrolyte may define a type of fuel cell. Electrolyte may include any number of substances like potassium hydroxide, salt carbonates, and phosphoric acid. Commonly a fuel cell is fueled by hydrogen. Fuel cell may feature an anode catalyst, like fine platinum powder, which breaks down fuel into electrons and ions. Fuel cell may feature a cathode catalyst, often nickel, which converts ions into waste chemicals, with water being the most common type of waste. A fuel cell may include gas diffusion layers that are designed to resist oxidization.

With continued reference to FIG. 3, aircraft 300 may include an energy source which may include a cell such as a battery cell, or a plurality of battery cells making a battery module. An energy source may be a plurality of energy sources. The module may include batteries connected in parallel or in series or a plurality of modules connected either in series or in parallel designed to deliver both the power and energy requirements of the application. Connecting batteries in series may increase the voltage of an energy source which may provide more power on demand. High voltage batteries may require cell matching when high peak load is needed. As more cells are connected in strings, there may exist the possibility of one cell failing which may increase resistance in the module and reduce the overall power output as the voltage of the module may decrease as a result of that failing cell. Connecting batteries in parallel may increase total current capacity by decreasing total resistance, and it also may increase overall amp-hour capacity. The overall energy and power outputs of an energy source may be based on the individual battery cell performance, or an extrapolation based on the measurement of at least an electrical parameter. In an embodiment where an energy source includes a plurality of battery cells, the overall power output capacity may be dependent on the electrical parameters of each individual cell. If one cell experiences high self-discharge during demand, power drawn from an energy source may be decreased to avoid damage to the weakest cell. An energy source may further include, without limitation, wiring, conduit, housing, cooling system and battery management system. Persons skilled in the art will be aware, after reviewing the entirety of this disclosure, of many different components of an energy source.

With continued reference to FIG. 3, aircraft 300 may include multiple flight component 308 sub-systems, each of which may have a separate energy source. For instance, and without limitation, one or more flight components 308 may have a dedicated energy source. Alternatively, or additionally, a plurality of energy sources may each provide power to two or more flight components 308, such as, without limitation, a “fore” energy source providing power to flight components located toward a front of an aircraft 300, while an “aft” energy source provides power to flight components located toward a rear of the aircraft 300. As a further non-limiting example, a flight component of group of flight components may be powered by a plurality of energy sources. For example, and without limitation, two or more energy sources may power one or more flight components; two energy sources may include, without limitation, at least a first energy source having high specific energy density and at least a second energy source having high specific power density, which may be selectively deployed as required for higher-power and lower-power needs. Alternatively, or additionally, a plurality of energy sources may be placed in parallel to provide power to the same single propulsor or plurality of propulsors 308. Alternatively, or additionally, two or more separate propulsion subsystems may be joined using intertie switches (not shown) causing the two or more separate propulsion subsystems to be treatable as a single propulsion subsystem or system, for which potential under load of combined energy sources may be used as the electric potential. Persons skilled in the art, upon reviewing the entirety of this disclosure, will be aware of various combinations of energy sources that may each provide power to single or multiple propulsors in various configurations.

With continued reference to FIG. 3, aircraft 300 may include a flight component 308 that includes at least a nacelle 308. For the purposes of this disclosure, a “nacelle” is a streamlined body housing, which is sized according to that which is houses, such as without limitation an engine, a fuel store, or a flight component. When attached by a pylon entirely outside an airframe 304 a nacelle may sometimes be referred to as a pod, in which case an engine within the nacelle may be referred to as a podded engine. In some cases, an aircraft cockpit may also be housed in a nacelle, rather than in a conventional fuselage. At least a nacelle may substantially encapsulate a propulsor, which may include a motor or an engine. At least a nacelle may be mechanically connected to at least a portion of aircraft 300 partially or wholly enveloped by an outer mold line of the aircraft 300. At least a nacelle may be designed to be streamlined. At least a nacelle may be asymmetrical about a plane comprising the longitudinal axis of the engine and the yaw axis of modular aircraft 300.

With continued reference to FIG. 3, a flight component may include a propulsor. A “propulsor,” as used herein, is a component or device used to propel a craft by exerting force on a fluid medium, which may include a gaseous medium such as air or a liquid medium such as water. For the purposes of this disclosure, “substantially encapsulate” is the state of a first body (e.g., housing) surrounding all or most of a second body. A motor may include without limitation, any electric motor, where an electric motor is a device that converts electrical energy into mechanical work for instance by causing a shaft to rotate. A motor may be driven by direct current (DC) electric power; for instance, a motor may include a brushed DC motor or the like. A motor may be driven by electric power having varying or reversing voltage levels, such as alternating current (AC) power as produced by an alternating current generator and/or inverter, or otherwise varying power, such as produced by a switching power source. A motor may include, without limitation, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers or other components for regulating motor speed, rotation direction, torque, and/or dynamic braking. Motor may include or be connected to one or more sensors detecting one or more conditions of motor; one or more conditions may include, without limitation, voltage levels, electromotive force, current levels, temperature, current speed of rotation, position sensors, and the like. For instance, and without limitation, one or more sensors may be used to detect back-EMF, or to detect parameters used to determine back-EMF, as described in further detail below. One or more sensors may include a plurality of current sensors, voltage sensors, and speed or position feedback sensors. One or more sensors may communicate a current status of motor to a flight controller and/or a computing device; computing device may include any computing device as described in this disclosure, including without limitation, a flight controller.

With continued reference to FIG. 3, a motor may be connected to a thrust element. Thrust element may include any device or component that converts mechanical work, for example of a motor or engine, into thrust in a fluid medium. Thrust element may include, without limitation, a device using moving or rotating foils, including without limitation one or more rotors, an airscrew or propeller, a set of airscrews or propellers such as contra-rotating propellers or co-rotating propellers, a moving or flapping wing, or the like. Thrust element may include without limitation a marine propeller or screw, an impeller, a turbine, a pump-jet, a paddle or paddle-based device, or the like. Thrust element may include a rotor. Persons skilled in the art, upon reviewing the entirety of this disclosure, will be aware of various devices that may be used as thrust element. A thrust element may include any device or component that converts mechanical energy (i.e., work) of a motor, for instance in form of rotational motion of a shaft, into thrust within a fluid medium. As another non-limiting example, a thrust element may include an eight-bladed pusher propeller, such as an eight-bladed propeller mounted behind the engine to ensure the drive shaft is in compression.

With continued reference to FIG. 3, in nonlimiting embodiments, at least a flight component 308 may include an airbreathing engine such as a jet engine, turbojet engine, turboshaft engine, ramjet engine, scramjet engine, hybrid propulsion system, turbofan engine, or the like. At least a flight component 308 may be fueled by any fuel described in this disclosure, for instance without limitation Jet-A, Jet-B, diesel fuel, gasoline, or the like. In nonlimiting embodiments, a jet engine is a type of reaction engine discharging a fast-moving jet that generates thrust by jet propulsion. While this broad definition can include rocket, water jet, and hybrid propulsion, the termjet engine, in some cases, refers to an internal combustion airbreathing jet engine such as a turbojet, turbofan, ramjet, or pulse jet. In general, jet engines are internal combustion engines. As used in this disclosure, a “combustion engine” is a mechanical device that is configured to convert mechanical work from heat produced by combustion of a fuel. In some cases, a combustion engine may operate according to an approximation of a thermodynamic cycle, such as without limitation a Carnot cycle, a Cheng cycle, a Combined cycle, a Brayton cycle, an Otto cycle, an Allam power cycle, a Kalina cycle, a Rankine cycle, and/or the like. In some cases, a combustion engine may include an internal combustion engine. An internal combustion engine may include heat engine in which combustion of fuel occurs with an oxidizer (usually air) in a combustion chamber that comprises a part of a working fluid flow circuit. Exemplary internal combustion engines may without limitation a reciprocating engine (e.g., 4-stroke engine), a combustion turbine engine (e.g., jet engines, gas turbines, Brayton cycle engines, and the like), a rotary engine (e.g., Wankel engines), and the like. In nonlimiting embodiments, airbreathing jet engines feature a rotating air compressor powered by a turbine, with leftover power providing thrust through a propelling nozzle—this process may be known as a Brayton thermodynamic cycle. Jet aircraft may use such engines for long-distance travel. Early jet aircraft used turbojet engines that were relatively inefficient for subsonic flight. Most modern subsonic jet aircraft use more complex high-bypass turbofan engines. In some cases, they give higher speed and greater fuel efficiency than piston and propeller aeroengines over long distances. A few air-breathing engines made for highspeed applications (ramjets and scramjets) may use a ram effect of aircraft's speed instead of a mechanical compressor. An airbreathing jet engine (or ducted jet engine) may emit a jet of hot exhaust gases formed from air that is forced into the engine by several stages of centrifugal, axial or ram compression, which is then heated and expanded through a nozzle. In some cases, a majority of mass flow through an airbreathing jet engine may be provided by air taken from outside of the engine and heated internally, using energy stored in the form of fuel. In some cases, a jet engine may include are turbofans. Alternatively and/or additionally, jet engine may include a turbojets. In some cases, a turbofan may use a gas turbine engine core with high overall pressure ratio (e.g., 40:1) and high turbine entry temperature (e.g., about 1800 K) and provide thrust with a turbine-powered fan stage. In some cases, thrust may also be at least partially provided by way of pure exhaust thrust (as in a turbojet engine). In some cases, a turbofan may have a high efficiency, relative to a turbojet. In some cases, a jet engine may use simple ram effect (e.g., ramjet) or pulse combustion (e.g., pulsejet) to give compression. Persons skilled in the art, upon reviewing the entirety of this disclosure, will be aware of various devices that may be used as a thrust element.

With continued reference to FIG. 3, an aircraft 300 may include a flight controller. As used in this disclosure, a “flight controller” is a device that generates signals for controlling at least a flight component 308 of an aircraft 300. In some cases, a flight controller includes electronic circuitry, such as without limitation a digital signal processor (DSP), an application-specific integrated circuit (ASIC), and/or a computing device. Flight controller may use sensor feedback to calculate performance parameters of motor, including without limitation a torque versus speed operation envelope. Persons skilled in the art, upon reviewing the entirety of this disclosure, will be aware of various devices and/or components that may be used as or included in a motor or a circuit operating a motor, as used and described in this disclosure.

With continued reference to FIG. 3, computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a lAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented using a “shared nothing” architecture in which data is cached at the worker, in an embodiment, this may enable scalability of system 300 and/or computing device.

With continued reference to FIG. 3, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

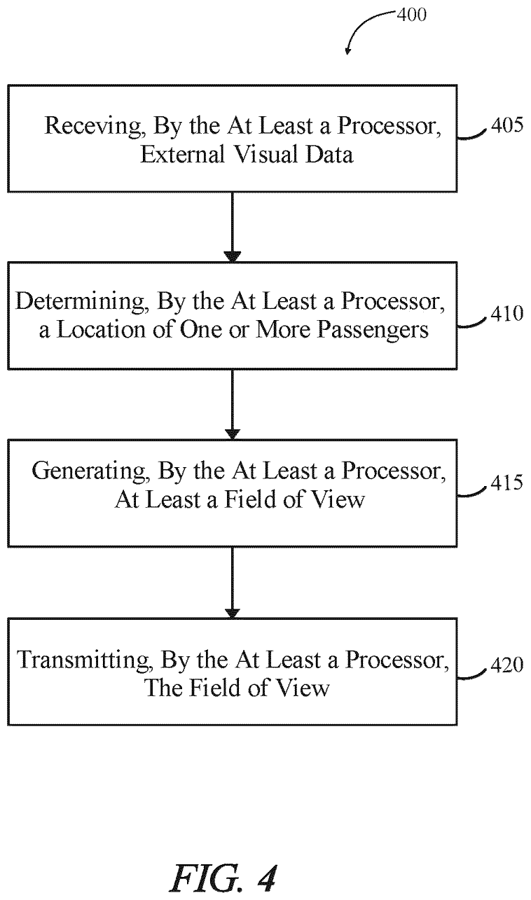

Referring now to FIG. 4, a flow diagram of a method 400 for virtually displaying an external visual environment of an aircraft is illustrated. At step 405, method 400 includes receiving, by at least a processor, external aircraft data from an input device. In some cases, external aircraft data made include aircraft orientation data. This may be implemented with reference to FIGS. 1-4.

With continued reference to FIG. 4, at step 410, method 400 includes determining, by the at least a processor, a location of one or more passengers. In some cases determining the location of one or more passengers comprises includes locating a passenger seat, locating the display device; and determining the location of one or more passengers as a function of the location of the passenger seat and the location of the display device. This may be implemented with reference to FIGS. 1-4.

With continued reference to FIG. 4, at step 415, method 400 includes generating, by the at least a processor, at least a field of view as a function of the external aircraft data and the location of the one or more passengers. In some embodiments, generating a field of view as a function of the external aircraft data and the location of the one or more passengers includes receiving eye-tracking data of the one or more passengers, determining a passenger perspective view of the one or more passengers as a function of the eye-tracking data and the location of the one or more passengers, and generating a field of view as a function of the external aircraft data and passenger perspective view. This may be implemented with reference to FIGS. 1-4.

With continued reference to FIG. 4, at step 420 method 400 includes transmitting, by the at least a processor, the field of view to a display device. In some cases, display device displays the field of view at a minimum of 60 frames per second. In some cases, memory further containing instructions configuring the processor the transmit a plurality of rest frames to the display device, the plurality of rest frames comprising virtually stationary components. In some cases, the display device is located on side of a fuselage of the aircraft. In some cases, transmitting the field of view to a display device further comprises transmitting the field of view to a user interface, the user interface displayed on the device display. In some cases, the method further comprises locating the device display within a blended wing body aircraft. This may be implemented with reference to FIGS. 1-4.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

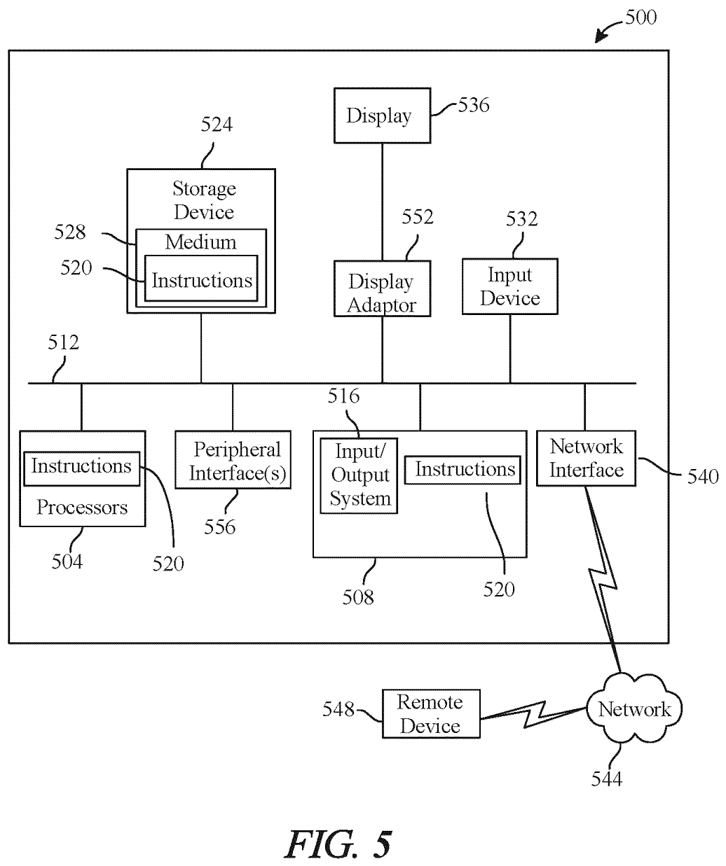

FIG. 5 shows a diagrammatic representation of one embodiment of a computing device in the exemplary form of a computer system 500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Processor 504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 504 may be organized according to Von Neumann and/or Harvard architecture as a non-limiting example. Processor 504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 508 may include various components (e.g., machine-readable media) including, but not limited to, a random-access memory component, a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Computer system 500 may also include a storage device 524. Examples of a storage device (e.g., storage device 524) include, but are not limited to, a hard disk drive, a magnetic disk drive, an optical disc drive in combination with an optical medium, a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1395 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 558 connected thereto. Examples of a network interface device include, but are not limited to, a network interface card (e.g., a mobile network interface card, a lAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for virtually displaying an external visual environment of an aircraft, the apparatus comprising:
an input device, wherein the input device is configured to receive external aircraft data of an aircraft;
at least a processor;
a memory communicatively connected to the at least a processor, wherein the memory contains instructions configuring the processor to:
obtain the external aircraft data from the input device, wherein the external aircraft data comprises a combination of real-time data, previously recorded data and virtually generated data;
determine a location of one or more passengers;
generate a field of view as a function of the external aircraft data and the location of the one or more passengers; and
transmit the field of view to a display device.

2. The apparatus of claim 1, wherein the external aircraft data comprises aircraft orientation data.

3. The apparatus of claim 1, wherein the virtually generated data comprises virtually generated data of an outside of the aircraft.

4. The apparatus of claim 1, wherein determining the location of the one or more passengers comprises:
locating a passenger seat;
locating the display device; and
determining the location of the one or more passengers as a function of the location of the passenger seat and the location of the display device.

5. The apparatus of claim 1, wherein generating the field of view as a function of the external aircraft data and the location of the one or more passengers comprises:
receiving eye-tracking data of the one or more passengers;
determining a passenger perspective view of the one or more passengers as a function of the eye-tracking data and the location of the one or more passengers; and
generating the field of view as a function of the external aircraft data and the passenger perspective view.

6. The apparatus of claim 1, wherein the display device displays the field of view at a minimum of 60 frames per second.

7. The apparatus of claim 1, the memory further containing instructions configuring the processor to transmit a plurality of rest frames to the display device, the plurality of rest frames comprising virtually stationary components.

8. The apparatus of claim 1 wherein the display device is located on a side of a fuselage of the aircraft.

9. The apparatus of claim 1, wherein transmitting the field of view to the display device further comprises transmitting the field of view to a user interface, wherein the user interface is displayed on the device display.

10. The apparatus of claim 1, further comprising a blended wing body aircraft, wherein the device display is located within a blended wing body of the blended wing body aircraft.

11. A method for virtually displaying an external visual environment of an aircraft, the method comprising:
receiving, by at least a processor, external aircraft data from an input device, wherein the external aircraft data comprises a combination of real-time data, previously recorded data and virtually generated data;
determining, by the at least a processor, a location of one or more passenger;
generating, by the at least a processor, at least a field of view as a function of the external aircraft data and the location of the one or more passengers; and
transmitting, by the at least a processor, the field of view to a display device.

12. The method of claim 11, wherein the external aircraft data comprises aircraft orientation data.

13. The method of claim 11, wherein the virtually generated data comprises virtually generated data of an outside of the aircraft.

14. The method of claim 11, wherein determining the location the of one or more passengers comprises:
locating a passenger seat;
locating the display device; and
determining the location of the one or more passengers as a function of the location of the passenger seat and the location of the display device.

15. The method of claim 11, wherein generating the field of view as a function of the external aircraft data and the location of the one or more passengers comprises:
receiving eye-tracking data of the one or more passengers;
determining a passenger perspective view of the one or more passengers as a function of the eye-tracking data and the location of the one or more passengers; and
generating the field of view as a function of the external aircraft data and the passenger perspective view.

16. The method of claim 11, wherein the display device displays the field of view at a minimum of 60 frames per second.

17. The method of claim 11, the memory further containing instructions configuring the processor to transmit a plurality of rest frames to the display device, the plurality of rest frames comprising virtually stationary components.

18. The method of claim 11 wherein the display device is located on a side of a fuselage of the aircraft.

19. The method of claim 11, wherein transmitting the field of view to the display device further comprises transmitting the field of view to a user interface, wherein the user interface is displayed on the device display.

20. The method of claim 11, the method further comprising locating the device display within a blended wing body aircraft.
